(19) United States
(12) Patent Application Publication
(10) Pub. No.: US 2020/0156997 A1
(43) Pub. Date: May 21, 2020

(54) LAMINATED GLASS ARTICLES COMPRISING A HYDROGEN-CONTAINING GLASS CORE LAYER AND METHODS OF FORMING THE SAME

(71) Applicant: CORNING INCORPORATED, Corning, NY (US)

(72) Inventors: Timothy Michael Gross, Corning, NY (US); Adam Robert Sarafian, Painted Post, NY (US); Jingshi Wu, Painted Post, NY (US); Zheming Zheng, Horseheads, NY (US)

(21) Appl. No.: 16/682,108

(22) Filed: Nov. 13, 2019

Related U.S. Application Data
(60) Provisional application No. 62/848,866, filed on May 16, 2019.
(60) Provisional application No. 62/768,383, filed on Nov. 16, 2018.

(51) Int. Cl. C03C 21/00; B32B 17/00; C03B 17/06; C03C 3/078; C03C 3/097

(52) U.S. Cl. CPC C03C 21/007; B32B 17/00; C03B 17/064; C03C 3/078; B32B 2605/00; B32B 2250/03; B32B 2250/40; B32B 2307/30; C03C 3/097

(57) ABSTRACT

Laminated glass articles and glass-based articles are disclosed. According to one embodiment, a laminated glass article includes a glass core layer comprising an average core coefficient of thermal expansion CTE_{C} and at least one glass clad layer fused directly to the glass core layer, the at least one glass clad layer comprising an average clad coefficient of thermal expansion CTE_{CL}. CTE_{C} is greater than or equal to CTE_{CL}. The glass core layer, the glass clad layer, or both, include a hydrogen-containing core zone.

### CROSS-REFERENCE TO RELATED APPLICATIONS

This application claims the benefit of priority under of U.S. Provisional Application Ser. No. 62/848,866 filed on May 16, 2019 and U.S. Provisional Application Ser. No. 62/768,383 filed on Nov. 16, 2018, the content of each is relied upon and incorporated herein by reference in their entirety.

### BACKGROUND

### Field

The present specification generally relates to glass articles and, more specifically, to glass articles comprising a hydrogen-containing zone and methods of forming the same.

### Technical Background

Glass articles, such as cover glasses, glass backplanes and the like, are employed in both consumer and commercial electronic devices such as LCD and LED displays, computer monitors, automated teller machines (ATMs) and the like. Some of these glass articles may include “touch” functionality which necessitates that the glass article be contacted by various objects including a user's fingers and/or stylus devices and, as such, the glass must be sufficiently robust to endure regular contact without damage, such a scratching. Indeed, scratches introduced into the surface of the glass article may reduce the strength of the glass article as the scratches may serve as initiation points for cracks leading to catastrophic failure of the glass.

Moreover, such glass articles may also be incorporated in portable electronic devices, such as mobile telephones, personal media players, laptop computers and tablet computers. The glass articles incorporated in these devices may be susceptible to sharp impact damage during transport and/or use of the associated device. Sharp impact damage may include, for example, damage caused by dropping the device. Such mechanical damage may lead to failure of the glass, particularly when the mechanical damage is incident on the edge of the glass.

Accordingly, a need exists for alternative glass articles that are resistant to failure due to mechanical damage incident on the surfaces and edges of the glass article.

### SUMMARY

The laminated glass articles, glass-based articles, and methods described herein may be understood according to various aspects including at least the following Aspects.

Aspect 1: A laminated glass article comprising a glass core layer formed from a core glass composition and comprising an average core coefficient of thermal expansion CTE_{C} from 20° C. temperature to 300° C.; and at least one glass clad layer fused directly to the glass core layer, the at least one glass clad layer formed from a clad glass composition different than the core glass composition, the at least one glass clad layer comprising an average clad coefficient of thermal expansion CTE_{CL} from 20° C. to 300° C., wherein: CTE_{C} is greater than or equal to CTE_{CL}; at least a portion of the glass core layer is exposed at an edge of the laminated glass article; and the glass core layer comprises a hydrogen-containing core zone extending from the edge of the laminated glass article towards a center of the glass core layer, wherein the hydrogen-containing core zone has a core zone penetration depth from the edge of the laminated glass article and a concentration of hydrogen in the hydrogen-containing core zone is greater closer to the edge of the laminated glass article than at the core zone penetration depth.

Aspect 2: The laminated glass article of Aspect 1, wherein the core zone penetration depth is greater than or equal to 2 μm.

Aspect 3: The laminated glass article of Aspect 1 or Aspect 2, wherein the hydrogen-containing core zone comprises a compressive stress, wherein the compressive stress decreases as the concentration of hydrogen in the glass core layer decreases.

Aspect 4: The laminated glass article of any of Aspects 1-3 wherein the compressive stress in the glass core layer in the hydrogen-containing core zone at the edge of the glass core layer is greater than or equal to 100 MPa.

Aspect 5: The laminated glass article of any of Aspects 1-4, wherein the compressive stress in the glass core layer extends from the edge of the glass core layer to a core zone depth of compression that is greater than or equal to 5 μm.

Aspect 6: The laminated glass article of any of Aspects 1-5, wherein a differential between CTE_{C} and CTE_{CL} is greater than or equal to 5×10⁻⁷/° C.

Aspect 7: The laminated glass article of any of Aspects 1-6, wherein the at least one glass clad layer comprises a compressive stress greater than or equal to 150 MPa.

Aspect 8: The laminated glass article of any of Aspects 1-7, wherein: the at least one glass clad layer comprises a hydrogen-containing clad zone extending from the edge of the laminated glass article towards a center of the at least one glass clad layer, wherein the hydrogen-containing clad zone has a clad zone penetration depth from the edge of the laminated glass article and a concentration of hydrogen in the hydrogen-containing clad zone is greater closer to the edge of the laminated glass article than at the clad zone penetration depth; and the core zone penetration depth is greater than the clad zone penetration depth.

Aspect 9: The laminated glass article of any of Aspects 1-8, wherein the clad zone penetration depth is less than 2 μm.

Aspect 10: The laminated glass article of any of Aspects 1-9, wherein the hydrogen-containing clad zone extends from a surface of the at least one glass clad layer to the clad zone penetration depth.

Aspect 11: The laminated glass article of any of Aspects 1-10, wherein the clad glass composition is free of alkali metal oxides.

Aspect 12: The laminated glass article of any of Aspects 1-11, wherein the core glass composition comprises SiO₂, Al₂O₃, and P₂O₅.

Aspect 13: A method of forming a laminated glass article, the method comprising fusing at least one glass clad layer directly to a glass core layer to form a laminated glass article, wherein: the glass core layer comprises an average core coefficient of thermal expansion CTE_{C} from 20° C. temperature to 300° C.; the at least one glass clad layer comprises an average clad coefficient of thermal expansion CTE_{CL} from 20° C. to 300° C.; and CTE_{C} is greater than or equal to CTE_{CL}; and exposing the laminated glass article to an environment comprising a vapor phase comprising greater than or equal to 300 grams of water/m³ thereby diffusing hydrogen into at least the glass core layer to form a hydrogen-containing core zone extending from an edge of the laminated glass article towards a center of the glass core layer, wherein the hydrogen-containing core zone has a core zone penetration depth from the edge of the laminated glass article and a concentration of hydrogen in the hydrogen-containing core zone is closer to the edge of the laminated glass article than at the core zone penetration depth.

Aspect 14: The method of Aspect 13, wherein the environment comprises a temperature greater than or equal to 70° C. during the exposing.

Aspect 15: The method of Aspect 13 or Aspect 14, wherein the environment comprises a pressure greater than or equal to 0.1 MPa.

Aspect 16: The method of any of Aspects 13-15, wherein the vapor phase comprises greater than or equal to 5000 grams of water/m³.

Aspect 17: The method of any of Aspects 13-16, wherein the laminated glass article is exposed to the environment comprising the vapor phase for a time greater than or equal to 0.25 days.

Aspect 18: The method of any of Aspects 13-17 further comprising singulating the laminated glass article from a larger glass article prior to the exposing.

Aspect 19: The method of any of Aspects 13-18, wherein after the exposing, the hydrogen-containing core zone comprises a compressive stress, wherein the compressive stress decreases as the concentration of hydrogen in the glass core layer decreases.

Aspect 20: The method of any of Aspects 13-19, wherein the exposing further comprises diffusing hydrogen into the at least one glass clad layer to form a hydrogen-containing clad zone extending from the edge of the laminated glass article towards a center of the at least one glass clad layer, wherein: the hydrogen-containing clad zone has a clad zone penetration depth from the edge of the laminated glass article; a concentration of hydrogen in the hydrogen-containing clad zone is greater closer to the edge of the laminated glass article than at the clad zone penetration depth; and the core zone penetration depth is greater than the clad zone penetration depth.

Aspect 21: A glass-based article, comprising: a compressive stress layer extending from a surface of the glass-based article to a depth of compression; a thickness of less than or equal to 2 mm; and a hydrogen-containing layer extending from the surface of the glass-based article to a depth of layer, wherein a hydrogen concentration of the hydrogen-containing layer decreases from a maximum hydrogen concentration to the depth of layer; wherein the depth of compression is greater than 5 μm, the compressive stress layer comprises a compressive stress greater than or equal to 10 MPa, and at least a portion of the glass-based article comprises a glass composition comprising greater than or equal to about 1 mol % and less than or equal to 20 mol % Na₂O.

Aspect 22: The glass-based article of Aspect 21, wherein the depth of layer is greater than 5 μm.

Aspect 23: The glass-based article of any of Aspects 21 to 22, wherein the depth of compression is greater than or equal to 7 μm.

Aspect 24: The glass-based article of any of Aspects 21 to 23, wherein the compressive stress is greater than or equal to 150 MPa.

Aspect 25: The glass-based article of any of Aspects 21 to 24, wherein the glass composition comprises less than or equal to about 8 mol % P₂O₅.

Aspect 26: The glass-based article of any of Aspects 21 to 25, wherein the glass composition comprises greater than or equal to about 3 mol % and less than or equal to about 20 mol % Al₂O₃.

Aspect 27: A method of forming a glass-based article, the method comprising: exposing a glass article to an environment comprising a vapor phase comprising greater than or equal to 300 grams of water/m³ thereby diffusing hydrogen into the glass article to form a hydrogen-containing layer extending from the surface of the glass-based article to a depth of layer, wherein a hydrogen concentration of the hydrogen-containing layer decreases from a maximum hydrogen concentration to the depth of layer; wherein the glass article comprises a glass composition comprising greater than or equal to about 1 mol. % and less than or equal to 20 mol. % Na₂O.

Aspect 28: The glass-based article of Aspect 28, wherein the environment comprises a temperature greater than or equal to 70° C. during the exposing.

Aspect 29: The glass-based article of any of Aspects 27 to 28, wherein the environment comprises a pressure greater than or equal to 0.1 MPa.

Aspect 30: A laminated glass article comprising: a glass core layer formed from a core glass composition and comprising an average core coefficient of thermal expansion CTE_{C} from 20° C. temperature to 300° C.; and at least one glass clad layer fused directly to the glass core layer, the at least one glass clad layer formed from a clad glass composition different than the core glass composition, the at least one glass clad layer comprising an average clad coefficient of thermal expansion CTE_{CL} from 20° C. to 300° C., wherein: CTE_{C} is greater than or equal to CTE_{CL}; and the glass clad layer comprises a hydrogen-containing clad zone extending from the surface of the laminated glass article into the thickness of the glass clad layer, wherein the hydrogen-containing core zone has a clad zone penetration depth from the surface of the laminated glass article and a concentration of hydrogen in the hydrogen-containing clad zone is greater closer to the surface of the laminated glass article than at the clad zone penetration depth.

Aspect 31: The laminated glass article of Aspect 30, wherein the clad zone penetration depth is greater than or equal to 2 μm.

Aspect 32: The laminated glass article of any of Aspects 30 to 31, wherein the hydrogen-containing clad zone comprises a compressive stress, wherein the compressive stress decreases as the concentration of hydrogen in the glass clad layer decreases.

Aspect 33: The laminated glass article of any of Aspects 30 to 32, wherein the compressive stress in the glass clad layer in the hydrogen-containing clad zone at the surface of the laminated glass article is greater than or equal to 100 MPa.

Aspect 34: The laminated glass article of any of Aspects 30 to 33, wherein the compressive stress in the glass clad layer extends from the surface of the glass clad layer to a clad zone depth of compression that is greater than or equal to 5 μm.

Aspect 35: The laminated glass article of any of Aspects 30 to 34, wherein a differential between CTE_{C} and CTE_{CL} is greater than or equal to 5×10⁻⁷/° C.

Aspect 36: The laminated glass article of any of Aspects 30 to 35, wherein the CTE_{CL} is less than or equal to about 100×10⁻⁷/° C.

Aspect 37: The laminated glass article of any of Aspects 30 to 36, wherein the at least one glass clad layer comprises a compressive stress greater than or equal to 150 MPa.

Aspect 38: The laminated glass article of any of Aspects 30 to 37, wherein the glass clad layer comprises greater than or equal to about 1 mol. % and less than or equal to 20 mol. % Na₂O.

Aspect 39: A method of forming a laminated glass article, the method comprising: fusing at least one glass clad layer directly to a glass core layer to form a laminated glass article, wherein: the glass core layer comprises an average core coefficient of thermal expansion CTE_{C} from 20° C. temperature to 300° C.; the at least one glass clad layer comprises an average clad coefficient of thermal expansion CTE_{CL} from 20° C. to 300° C.; and CTE_{C} is greater than or equal to CTE_{CL}; and exposing the laminated glass article to an environment comprising a vapor phase comprising greater than or equal to 300 grams of water/m³ thereby diffusing hydrogen into at least the glass clad layer to form a hydrogen-containing clad zone extending from a surface of the laminated glass article into the thickness of the glass clad layer, wherein the hydrogen-containing clad zone has a clad zone penetration depth from the surface of the laminated glass article and a concentration of hydrogen in the hydrogen-containing clad zone is closer to the surface of the laminated glass article than at the clad zone penetration depth.

Aspect 40: The method of Aspect 39, wherein the environment comprises a temperature greater than or equal to 70° C. during the exposing, the environment comprises a pressure greater than or equal to 0.1 MPa, or both.

Additional features and advantages of the laminated glass articles and methods for forming the same described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of a laminated glass article according to one or more embodiments shown and described herein;

FIG. 2 schematically depicts an apparatus for forming a laminated glass article according to one or more embodiments shown and described herein;

FIG. 3 schematically depicts a cross section of a laminated glass article indicating compressive stress and tensile stress in the glass article due to lamination, according to one or more embodiments shown and described herein;

FIG. 4 schematically depicts a cross section of a laminated glass article comprising hydrogen-containing zones in the glass core layer, according to one or more embodiments shown and described herein;

FIG. 5 schematically depicts a cross section of a laminated glass article depicting interface regions between the glass core layer and the glass clad layers, according to one or more embodiments shown and described herein;

FIG. 6 schematically depicts a cross section of a laminated glass article comprising hydrogen-containing zones in a glass clad layer, according to one or more embodiments shown and described herein;

FIG. 7 schematically depicts an apparatus for diffusing hydrogen-containing species into a glass article, such as a laminated glass article, according to one or more embodiments described herein;

FIG. 8A schematically depicts a front view of a consumer electronic device comprising a laminated glass article, according to one or more embodiments described herein;

FIG. 8B schematically depicts a perspective view of a consumer electronic device comprising a laminated glass article, according to one or more embodiments described herein;

FIG. 9 graphically depicts the concentration of hydrogen (left Y ordinate) and the concentration of calcium (right Y ordinate) as function of depth (X ordinate) for glass clad layer composition CL5 both before and after exposure to an environment containing water vapor;

FIG. 10 graphically depicts the concentration of hydrogen (left Y ordinate) and the concentration of boron (right Y ordinate) as function of depth (X ordinate) for glass clad layer composition CL1 both before and after exposure to an environment containing water vapor;

FIG. 11 graphically depicts the concentration of hydrogen (left Y ordinate) and the concentration of aluminum (right Y ordinate) as function of depth (X ordinate) for glass clad layer composition C1 both before and after exposure to an environment containing water vapor;

FIG. 12 graphically depicts the scaled relative intensity of hydrogen, phosphorous, and aluminum (left Y ordinate) as function of depth (X ordinate) for glass core layer composition CL2 after exposure to an environment containing water vapor; and

FIG. 13 schematically depicts of a cross-section of a glass-based article according to an embodiment.

### DETAILED DESCRIPTION

Reference will now be made in detail to embodiments of laminated glass articles and glass-based articles comprising hydrogen-containing zones in at least the glass core layer, the glass clad layer, or both, examples of which are illustrated in the accompanying drawings. Whenever possible, the same reference numerals will be used throughout the drawings to refer to the same or like parts.

One embodiment of a laminated glass article is schematically depicted in FIG. 3, and is designated generally throughout by the reference numeral 100. The laminated glass article generally comprises a glass core layer formed from a core glass composition and comprising an average core coefficient of thermal expansion CTE_{C} from 20° C. temperature to 300° C. and at least one glass clad layer fused directly to the glass core layer. The at least one glass clad layer is formed from a clad glass composition different than the core glass composition and comprises an average clad coefficient of thermal expansion CTE_{CL} from 20° C. to 300° C. CTE_{C} is greater than or equal to CTE_{CL}. At least a portion of the glass core layer may be exposed at an edge of the laminated glass article. The glass core layer may include a hydrogen-containing core zone extending from the edge of the laminated glass article towards a center of the glass core layer. The hydrogen-containing core zone may have a core zone penetration depth from the edge of the laminated glass article and a concentration of hydrogen in the hydrogen-containing core zone is greater closer to the edge of the laminated glass article than at the core zone penetration depth. In additional embodiments, the glass clad layer may include a hydrogen-containing clad zone extending from the surface of the laminated glass article towards the interior of the laminated glass article (i.e., into the clad layer from the major surface). Various embodiments of laminated glass articles comprising hydrogen-containing zones in at least the glass core layer, the glass clad layer, or both, and methods of making the same will be described herein with specific reference to the appended drawings.

One or more additional embodiments of the present disclosure are directed to glass compositions which include Na₂O, such as Na₂O in an amount of from about 1 mol. % to about 20 mol. %. Such glass compositions may, in some embodiments, include P₂O₅ in relatively small amounts, such as less than or equal to 8 mol. %. The glass compositions may form glass-based articles that include hydrogen containing zones extending from their surfaces and into the thicknesses of the glass-based articles. Such glass-based articles may be non-laminated glass sheets. In one or more embodiments, the glass compositions which include Na₂O may be utilized as the material of the glass clad layer in a laminated glass article. Such glass compositions may be well suited for use in the glass clad layer due to at least their relatively low coefficient of thermal expansion and propensity to strengthen when exposed to, for example, a steam treatment to form a hydrogen containing zone.

Ranges can be expressed herein as from “about” one particular value, and/or to “about” another particular value. When such a range is expressed, another embodiment includes from the one particular value and/or to the other particular value (i.e., the range is inclusive of the expressly stated endpoints). Similarly, when values are expressed as approximations, by use of the antecedent “about,” it will be understood that the particular value forms another embodiment. For example, the range “from about 1 to about 2” also expressly includes the range “from 1 to 2”. Similarly, the range “about 1 to about 2” also expressly includes the range of “1 to 2”. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “CTE,” as used herein, refers to the coefficient of thermal expansion of the glass composition averaged over a temperature range from about 20° C. to about 300° C.

The elastic modulus (also referred to as Young's modulus) of different layers of the glass laminate is provided in units of gigapascals (GPa). The elastic modulus of the glass is determined by resonant ultrasound spectroscopy on bulk samples of each glass composition.

Compressive stress (including surface compressive stress) is measured with a surface stress meter (FSM) such as commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is also measured with the FSM. The maximum central tension (CT) values are measured using a scattered light polariscope (SCALP) technique known in the art.

The phrase “depth of compression” and “DOC” refer to the position in the glass where compressive stress transitions to tensile stress.

In the embodiments described herein, the zone penetration depth (e.g., the clad zone penetration depth and the core zone penetration depth) and hydrogen concentration are measured by a secondary ion mass spectrometry (SIMS) technique known in the art. The SIMS technique is capable of measuring the hydrogen concentration at a given depth, but is not capable of distinguishing the hydrogen species present in the glass article. For this reason, all hydrogen species contribute to the SIMS measured hydrogen concentration. As utilized herein, the zone penetration depth refers to the distance from the surface (or edge) of the glass article to the point where the hydrogen concentration is equal to the hydrogen concentration at the center of the glass article. This definition accounts for the hydrogen concentration of the glass article prior to treatment in an environment containing water vapor, such that the zone penetration depth refers to the depth to which hydrogen penetrates into the glass article due to the treatment process. As a practical matter, the hydrogen concentration at the center of the glass article may be approximated by the hydrogen concentration at the depth from the surface (or edge) of the glass article where the hydrogen concentration becomes substantially constant, as the hydrogen concentration is not expected to change between such a depth and the center of the glass article.

Conventionally, strengthened glass articles can be formed by lamination as described in U.S. Pat. No. 4,214,886. Specifically, glass clad layers having a relatively low coefficient of thermal expansion (CTE) can be fused to a glass core layer having a relatively high coefficient of thermal expansion. The fusing process takes place at a relatively high temperature such that, as the glass clad layers and the glass core layers cool, the differential in the coefficients of thermal expansion between the glass clad layers and the glass core layer results in the development of compressive stress in the glass clad layers and a corresponding tensile stress in the glass core layer. The compressive stress in the glass core layers improves the resistance of the laminated glass article to failure due to mechanically induced damage, such as scratches or the like, on the surfaces of the laminated glass article.

In embodiments where discrete laminated glass articles are singulated from a larger sheet or ribbon of laminated glass, the singulation may expose the glass core layer and the tensile stress in the glass core layer along at least one edge of the discrete laminated glass article. Mechanical contact with the exposed glass core layer and, more particularly, mechanical contact with the exposed tensile stress in the exposed glass core layer, may result in catastrophic failure of the laminated glass article.

One or more embodiments of the laminated glass articles described herein mitigate the aforementioned problems in conventional laminated glass articles related to at least the exposure of the glass core at the edges of the laminated article. In particular, the embodiments of the laminated glass articles described herein may comprise a hydrogen-containing core zone extending from the edge of the laminated glass article towards a center of the glass core layer. The hydrogen in the hydrogen-containing core zone creates compressive stress in the glass core layer proximate the exposed edges of the glass core layer. The compressive stress in the glass core layer due to the hydrogen in the hydrogen-containing core zone mitigates the risk of failure due to mechanical contact with the exposed glass core layer at the edges of the laminated glass article.

One or more additional embodiments of the laminated glass articles described herein may enhance compressive stress in the glass clad layer(s). In particular, the embodiments of the laminated glass articles described herein may comprise a hydrogen-containing clad zone extending from the outer major surface of the laminated glass article into the thickness of the laminated glass article, towards the glass core layer. The hydrogen in the hydrogen-containing clad zone creates additional compressive stress in the glass clad layer proximate the outer major surface of the glass clad layer. The compressive stress in the glass clad layer due to the hydrogen in the hydrogen-containing core zone mitigates the risk of failure due to mechanical contact with the clad layers of the laminated glass article.

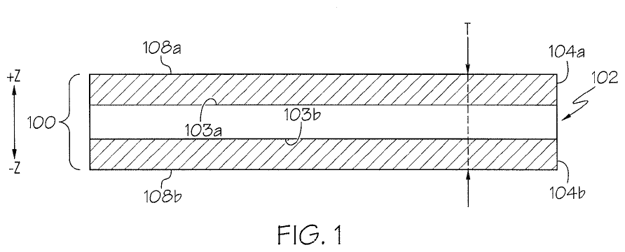

Referring now to FIG. 1, a laminated glass article 100 is schematically depicted in cross section. The laminated glass article 100 generally comprises a glass core layer 102 and at least one glass clad layer 104a. In the embodiment of the laminated glass article 100 shown in FIG. 1 the laminated glass article includes a first glass clad layer 104a and a second glass clad layer 104b positioned on opposite sides of the glass core layer 102. While FIG. 1 schematically depicts the laminated glass article 100 as being a laminated glass sheet, it should be understood that other configurations and form factors are contemplated and possible. For example, the laminated glass article may have a non-planar configuration such as a curved glass sheet or the like. Alternatively, the laminated glass article may be a laminated glass tube, container, or the like.

In the embodiment of the laminated glass articles 100 described herein, the glass core layer 102 generally comprises a first major surface 103a and a second major surface 103b which is opposed to the first major surface 103a. A first glass clad layer 104a is fused to the first major surface 103a of the glass core layer 102 and a second glass clad layer 104b is fused to the second major surface 103b of the glass core layer 102.

In the embodiments described herein, the glass clad layers 104a, 104b are fused to the glass core layer 102 without any additional non-glass materials, such as adhesives, coating layers or the like, being disposed between the glass core layer 102 and the glass clad layers 104a, 104b. Thus, in some embodiments, the glass clad layers 104a, 104b are fused directly to the glass core layer 102 or are directly adjacent to the glass core layer 102.

Still referring to FIG. 1, in the embodiments described herein, the laminated glass articles 100 are formed such that there is a mismatch between the coefficients of thermal expansion (CTE) of the glass core layer 102 and the glass clad layers 104a, 104b. This mismatch in the CTEs of the glass core layer 102 and the glass clad layers 104a, 104b results in the formation of compressive stress extending from the surfaces 108a, 108b of the laminated glass article 100 into the thickness of laminated glass article. For example, in some embodiments described herein, the glass clad layers 104a, 104b are formed from glass compositions which have an average clad coefficient of thermal expansion CTE_{CL} and the glass core layer 102 is formed from a different glass composition which has an average core coefficient of thermal expansion CTE_{C}. CTE_{C} is greater than CTE_{CL} (i.e., CTE_{C}>CTE_{CL}) which results in the glass clad layers 104a, 104b being compressively stressed.

The compressive stress in the clad due to the CTE differential between the glass core layer and the glass clad layers may be approximated with the following equations:

$$\frac{{α}_{clad}}{{α}_{core}} = - ( \frac{{t}_{core}}{2 {t}_{clad}} ) = - k ;$$

$${σ}_{clad} = \frac{( {α}_{clad} - {α}_{core} ) Δ T}{\frac{1}{{kE}_{core}^{eff}} + \frac{1}{{E}_{clad}^{eff}} - Δ T ( \frac{{α}_{core}}{{kE}_{core}^{eff}} + \frac{{α}_{clad}}{{E}_{clad}^{eff}} )} ;$$

$${E}_{core}^{eff} = \frac{{E}_{core}}{( 1 + {v}_{core} ) ( 1 - 2 {v}_{core} )} ;$$

$${E}_{clad}^{eff} = \frac{{E}_{clad}}{( 1 + {v}_{clad} ) ( 1 - 2 {v}_{clad} )} ;$$

where t_{core} is the core thickness, t_{clad} is the clad thickness, α_{clad} is the clad coefficient of thermal expansion, α_{core} is the core coefficient of thermal expansion, ΔT is the effective temperature difference, E_{core} is the elastic modulus of the core, E_{clad} is the elastic modulus of the clad, v_{core} is the Poisson's ratio of the core and v_{clad} is the Poisson's ratio of the clad. In general α_{clad}<<ΔT and α_{core}ΔT<<1, hence:

$${σ}_{clad} \approx \frac{( {α}_{clad} - {α}_{core} ) Δ T}{\frac{1}{{kE}_{core}^{eff}} + \frac{1}{{E}_{clad}^{eff}}} ,$$

For example, in some embodiments, the glass clad layers are formed from glass compositions which have an average clad CTE_{CL} less than or equal to about 100×10⁻⁷/° C. averaged over a range from 20° C. to 300° C. In some embodiments, the average clad CTE_{CL} of the clad glass compositions may be less than or equal to about 90×10⁻⁷/° C., less than or equal to about 80×10⁻⁷/° C., or less than or equal to or about 70×10⁻⁷/° C. averaged over a range from 20° C. to 300° C. In some embodiments, the average clad CTE_{CL} of the clad glass compositions may be less than or equal to about 65×10⁻⁷/° C. averaged over a range from 20° C. to 300° C. In some embodiments, the average clad CTE_{CL} of the clad glass compositions may be less than or equal to about 60×10⁻⁷/° C. averaged over a range from 20° C. to 300° C. or even less than or equal to about 55×10⁻⁷/° C. averaged over a range from 20° C. to 300° C.

However, the glass core layer may be formed from a glass composition which has an average coefficient of thermal expansion greater than that of the material of the clad. For example, the glass core layer may be formed from a glass composition which has an average coefficient of thermal expansion of greater than or equal to about 72×10⁻⁷/° C. in a range from 20° C. to 300° C. In some embodiments, the average core CTE_{C} of the core glass composition of the glass core layer may be greater than or equal to about 75×10⁻⁷/° C. in a range from 20° C. to 300° C. In some embodiments, the average core CTE_{C} of the glass composition of the glass core layer may be greater than or equal to about 80×10⁻⁷/° C. averaged over a range from 20° C. to 300° C. In some embodiments, the average core CTE_{C} of the glass composition of the glass core layer may be greater than or equal to about 90×10⁻⁷/° C. averaged over a range from 20° C. to 300° C.

In one or more of the embodiments described herein, the CTE differential between the glass core layer 102 and the glass clad layers 104a, 104b (i.e., |CTE_{C}−CTE_{CL}|) is sufficient to generate a compressive stress in the clad layers. In some embodiments, the CTE differential between the glass core layer 102 and the glass clad layers 104a, 104b is sufficient to create a compressive stress in the glass clad layers 104a, 104b of greater than or equal to 100 MPa which extends from a surface of the glass clad layer 104a, 104b and through the thickness of the glass clad layers 104a, 104b. In some embodiments, the compressive stress in the glass clad layers 104a, 104b due to the CTE differential is greater than or equal to 120 MPa, greater than or equal to 150 MPa, or even greater than 200 MPa.

In some embodiments the CTE differential between the glass core layer and the glass clad layers is greater than or equal to about 5×10⁻⁷/° C. or even 10×10⁻⁷/° C. In some embodiments, the CTE differential between the glass core layer and the glass clad layers is greater than or equal to about 20×10⁻⁷/° C. or even 30×10⁻⁷/° C. In some embodiments, the CTE differential between the glass core layer and the glass clad layers is greater than or equal to about 40×10⁻⁷/° C. or even 50×10⁻⁷/° C.

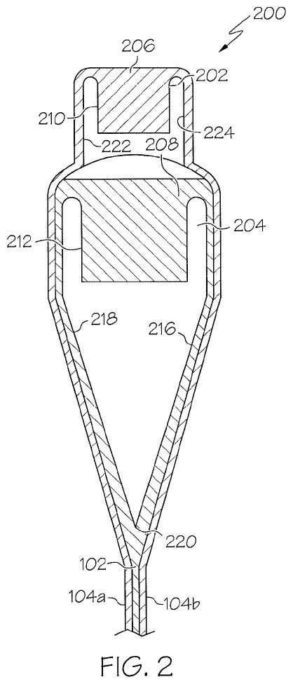

Various techniques may be used to form the laminated glass article. In one particular embodiment, the laminated glass articles 100 described herein may be formed by a fusion lamination process such as the process described in U.S. Pat. No. 4,214,886, which is incorporated herein by reference. Referring to FIG. 2 by way of example, a laminate fusion draw apparatus 200 for forming a laminated glass article includes an upper overflow distributor or isopipe 202 which is positioned over a lower overflow distributor or isopipe 204. The upper overflow distributor 202 includes a trough 210 into which a molten glass clad composition 206 is fed from a melter (not shown). Similarly, the lower overflow distributor 204 includes a trough 212 into which a molten glass core composition 208 is fed from a melter (not shown).

As the molten glass core composition 208 fills the trough 212, it overflows the trough 212 and flows over the outer forming surfaces 216, 218 of the lower overflow distributor 204. The outer forming surfaces 216, 218 of the lower overflow distributor 204 converge at a root 220. Accordingly, the molten glass core composition 208 flowing over the outer forming surfaces 216, 218 rejoins at the root 220 of the lower overflow distributor 204 thereby forming a glass core layer 102 of a laminated glass article.

Simultaneously, the molten glass clad composition 206 overflows the trough 210 formed in the upper overflow distributor 202 and flows over outer forming surfaces 222, 224 of the upper overflow distributor 202. The molten glass clad composition 206 is outwardly deflected by the upper overflow distributor 202 such that the molten glass clad composition 206 flows around the lower overflow distributor 204 and contacts the molten glass core composition 208 flowing over the outer forming surfaces 216, 218 of the lower overflow distributor, fusing to the molten glass core composition and forming glass clad layers 104a, 104b around the glass core layer 102.

While FIG. 2 schematically depicts a particular apparatus for forming planar laminated glass articles such as sheets or ribbons, it should be appreciated that other geometrical configurations are possible. For example, cylindrical laminated glass articles may be formed, for example, using the apparatuses and methods described in U.S. Pat. No. 4,023,953.

In the embodiments described herein, the molten glass core composition 208 generally has an average core coefficient of thermal expansion CTE_{C} which is greater than the average clad coefficient of thermal expansion CTE_{CL} of the molten glass clad composition 206, as described herein above. Accordingly, as the glass core layer 102 and the glass clad layers 104a, 104b cool, the difference in the coefficients of thermal expansion of the glass core layer 102 and the glass clad layers 104a, 104b cause a compressive stresses to develop in the glass clad layers 104a, 104b and corresponding tensile stress to develop in the glass core layer 102. The compressive stress increases the strength of the resulting laminated glass article.

While FIG. 2 schematically depicts one embodiment of forming a laminated glass article according to the fusion lamination process, it should be understood that other methods for forming laminated glass articles are contemplated and possible. For example and without limitation, in an alternative embodiment, the laminated glass articles may be formed by stacking at least two discrete plies of glass and heating the stacked plies to fuse the plies together.

Referring now to FIG. 3, a laminated glass article 100 is schematically depicted following singulation from a larger laminated glass article (such as a sheet or ribbon) but prior to any additional treatments. After singulation, at least a portion of the glass core layer 102 is exposed at an edge of the laminated glass article 100. Specifically, after singulation, the glass core layer 102 comprises exposed edges 105a, 105b. As shown in FIG. 3, the laminated glass article 100 comprises compressive stress in the glass clad layers 104a, 104b due to the CTE differential between the glass clad layers 104a, 104b and the glass core layer 102. The development of compressive stress in the glass clad layers 104a, 104b is accompanied by the development of tensile stress in the glass core layer 102. Following singulation of the laminated glass article 100 from a larger laminated glass article, the tensile stress in the glass core layer 102 extends through the glass core layer 102 to the exposed edges 105a, 105b. As described herein, the tensile stress at the exposed edges 105a, 105b may increase the risk of catastrophic failure of the laminated glass article 100 due to mechanical contact with the tensile stress at the exposed edges 105a, 105b. To mitigate this risk, the laminated glass articles 100 described herein may be treated to introduce hydrogen-containing core zone(s) in the glass core layer 102 proximate the exposed edges. The hydrogen in the hydrogen-containing core zone induces compressive stress in the glass core layer 102 proximate the exposed edges, thereby mitigating the risk of failure of the laminated glass article 100 due to mechanical contact with tensile stresses in the glass core layer 102. In additional embodiments, the compressive stress may be increased in the glass clad layers 104a, 104b through the formation of a hydrogen-containing clad zone(s), increasing the difference in the stress profiles between the clad layers 104a, 104b and glass core layer 102. In some embodiments, the hydrogen-containing zone(s) are formed on the outer surfaces of the clad layers 104a, 104b as well as the exposed edges 105a, 105b of the glass core layer 102.

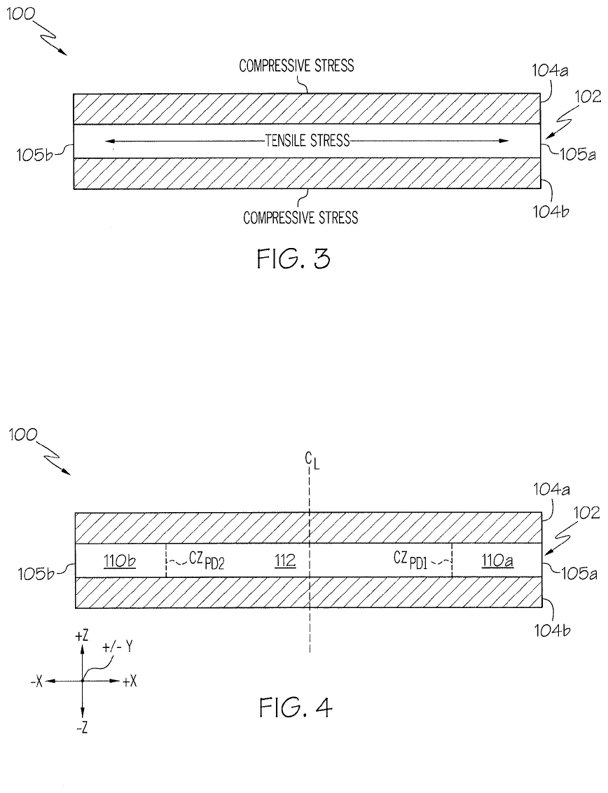

Referring now to FIG. 4, an embodiment of a laminated glass article 100 comprising hydrogen-containing core zones 110a, 110b proximate the exposed edges 105a, 105b of the glass core layer 102 is schematically depicted. Specifically, a first hydrogen-containing core zone 110a extends from the first exposed edge 105a of the glass core layer 102 to a first core zone penetration depth CZ_{PD1} measured from the first exposed edge 105a. Similarly, a second hydrogen-containing core zone 110b extends from the second exposed edge 105b of the glass core layer 102 to a second core zone penetration depth CZ_{PD2} measured from the second exposed edge 105b. As shown in FIG. 4, the hydrogen-containing core zones 110a, 110b are located in the glass core layer 102 and are bounded laterally (i.e., in the +/−X directions of the coordinate axes depicted in the figures) by the exposed edges (either exposed edge 105a or exposed edge 105b) and the core zone penetration depth (either CZ_{PD1} or CZ_{PD2}). The hydrogen-containing core zones 110a, 110b are bounded vertically (i.e., in the +/−Z directions of the coordinate axes depicted in the figures) by the glass clad layers 104a, 104b.

While FIG. 4 depicts two hydrogen-containing core zones 110a, 110b extending from the exposed edges 105a, 105b of the glass core layer 102, it should be understood that other embodiments are contemplated and possible including embodiments which include more than two hydrogen-containing core zones, and embodiments including less than two hydrogen-containing core zones. For example, in embodiments where only a single edge of the glass core layer 102 is exposed, the laminated glass article 100 may only include a single hydrogen-containing core zone.

In one or more of the embodiments described herein, the hydrogen-containing core zones 110a, 110b contain species of hydrogen (also referred to herein as “hydrogen-containing species) that are diffused into the glass core layer 102 by exposing the laminated glass article 100 to environments containing water vapor, as will be described in further detail herein. The composition of the glass core layer 102 may be selected to promote the diffusion of hydrogen-containing species into the glass. In some embodiments, the compositions of the glass clad layers 104a, 104b are selected to be less susceptible to the diffusion of hydrogen-containing species into the glass or even to discourage the diffusion of hydrogen-containing species into the glass, as will be described in further detail herein. However, in other embodiments, the compositions of the glass clad layers 104a, 104b are selected to also be susceptible to the diffusion of hydrogen-containing species into the glass or even to discourage the diffusion of hydrogen-containing species into the glass. In additional embodiments, the composition of the glass core layer 102 may be selected to discourage the diffusion of hydrogen-containing species into the glass core layer 102 while the compositions of the glass clad layers 104a, 104b are selected to be susceptible to the diffusion of hydrogen-containing species into the glass.

In one or more embodiments, the core zone penetration depths CZ_{PD1}, CZ_{PD2} of the hydrogen-containing core zones 110a, 110b in the glass core layer 102 may be greater than or equal to 2 μm, such as greater than or equal to about 2.5 μm or even greater than or equal to about 3 μm from the corresponding exposed edges 105a, 105b of the glass core layer 102. In some embodiments, the core zone penetration depths CZ_{PD1}, CZ_{PD2} of the hydrogen-containing core zones 110a, 110b may be greater than about 5 μm, such as greater than about 10 μm, greater than about 15 μm, greater than about 20 μm, greater than about 25 μm, greater than about 30 μm, greater than about 35 μm, greater than about 40 μm, greater than about 45 μm, greater than about 50 μm, greater than about 55 μm, greater than about 60 μm, greater than about 65 μm, greater than about 70 μm, greater than about 75 μm, greater than about 80 μm, greater than about 85 μm, greater than about 90 μm, greater than about 95 μm, greater than about 100 μm, greater than about 105 μm, greater than about 110 μm, greater than about 115 μm, greater than about 120 μm, greater than about 125 μm, greater than about 130 μm, greater than about 135 μm, greater than about 140 μm, greater than about 145 μm, greater than about 150 μm, greater than about 155 μm, greater than about 160 μm, greater than about 165 μm, greater than about 170 μm, greater than about 175 μm, greater than about 180 μm, greater than about 185 μm, greater than about 190 μm, greater than about 195 μm, greater than about 200 μm, or more. In embodiments, the core zone penetration depths CZ_{PD1}, CZ_{PD2} of the hydrogen-containing core zones 110a, 110b may be 2.5 μm or even about 3 μm to about 205 μm, such as about 5 μm to about 200 μm, about 15 μm to about 195 μm, about 20 μm to about 190 μm, about 25 μm to about 185 μm, about 30 μm to about 180 μm, about 35 μm to about 175 μm, about 40 μm to about 170 μm, about 45 μm to about 165 μm, about 50 μm to about 160 μm, about 55 μm to about 155 μm, about 60 μm to about 150 μm, about 65 μm to about 145 μm, about 70 μm to about 140 μm, about 75 μm to about 135 μm, about 80 μm to about 130 μm, about 85 μm to about 125 μm, about 90 μm to about 120 μm, about 95 μm to about 115 μm, about 100 μm to about 110 μm, or any sub-ranges formed by any of these endpoints. In general, the core zone penetration depths CZ_{PD1}, CZ_{PD2} of the hydrogen-containing core zones 110a, 110b are greater than the hydrogen penetration depth due to exposure of the laminated glass article to the ambient environment.

In the embodiments described herein, the core zone penetration depths CZ_{PD1}, CZ_{PD2} of the hydrogen-containing core zones 110a, 110b and the hydrogen concentration of the hydrogen-containing core zones 110a, 110b are measured by secondary ion mass spectrometry (SIMS) as noted herein.

Still referring to FIG. 4, each of the hydrogen-containing core zones 110a, 110b comprises a hydrogen concentration that decreases from a maximum value proximate (i.e., at or near) the corresponding exposed edge 105a, 105b of the glass core layer 102 to the corresponding core zone penetration depth CZ_{PD1}, CZ_{PD2} in a direction toward the center of the glass core layer 102 (indicated as C_{L} in FIG. 4). The hydrogen concentration is a minimum at the core zone penetration depths CZ_{PD1}, CZ_{PD2}. Accordingly, it should be understood that each of the hydrogen-containing core zones 110a, 110b comprise a hydrogen concentration gradient which decreases from a maximum value at or near the corresponding exposed edge 105a, 105b to the corresponding core zone penetration depth CZ_{PD1}, CZ_{PD2}.

In the embodiments described herein, the glass core layer 102 of the laminated glass article further comprises a central core zone 112 disposed between the first hydrogen-containing core zone 110a and the second hydrogen-containing core zone 110b. The central core zone 112 is free of any hydrogen-containing species intentionally added to the laminated glass article 100 following formation of the laminated glass article 100, such as hydrogen-containing species intentionally diffused into the glass by exposing the laminated glass article 100 to environments containing water vapor. In embodiments, the concentration of hydrogen is substantially constant throughout the central core zone 112. For example, the concentration of hydrogen may be substantially constant through the central core zone 112 from the first core zone penetration depth CZ_{PD1} to the second core zone penetration depth CZ_{PD2}. Similarly, the concentration of hydrogen may be substantially constant through the central core zone 112 from the first glass clad layer 104a to the second glass clad layer 104b.

As noted herein, the hydrogen-containing species in the hydrogen-containing core zones 110a, 110b create compressive stress in the glass of the glass core layer 102 within the hydrogen-containing core zones 110a, 110b. Without wishing to be bound by any theory, it is believe that the compressive stress in the hydrogen-containing core zones 110a, 110b is the result of the diffusion of hydrogen and/or hydrogen-containing species, such as H₂O, H₃O⁺ and/or H⁺ or the like, into the glass core layer 102. These hydrogen-containing species react with the glass network to cause a volumetric expansion which, in turn, develops compressive stress in the glass. The compressive stress generally varies with the concentration of hydrogen in the hydrogen-containing core zones 110a, 110b. In embodiments, the compressive stress is a maximum at or near the exposed edges 105a, 105b of the respective hydrogen-containing core zones 110a, 110b (i.e., where the concentration of hydrogen is a maximum) and decreases from the maximum with increasing distance from the maximum towards the respective core zone penetration depths CZ_{PD1}, CZ_{PD2} (i.e., towards a center C_{L} of the glass core layer 102). In general, the compressive stress is a minimum at or adjacent to the respective core zone penetration depths CZ_{PD1}, CZ_{PD2} (i.e., where the concentration of hydrogen is a minimum). As such, it should be understood that the regions of the glass core layer 102 that contain compressive stress are primarily located within the hydrogen-containing core zones 110a, 110b. In embodiments, the regions of the glass core layer 102 that contain compressive stress may be substantially or even entirely within the hydrogen-containing core zones 110a, 110b, including when the regions of compressive stress within the glass core layer 102 are co-extensive with the hydrogen-containing core zones 110a, 110b.

In the embodiments described herein that include hydrogen-containing core zones 110a, 110b, the compressive stress in the hydrogen-containing core zones 110a, 110b extends to a core zone depth of compression (i.e., a core zone DOC). As used herein, the phrases “core zone depth of compression” and “core zone DOC” refer to the depth or distance from the respective exposed edges 105a, 105b of the glass core layer 102 at which the stress in the glass-based article changes from compressive to tensile.

In some embodiments, the compressive stress in the hydrogen-containing core zones 110a, 110b may include a compressive stress of at least about 100 MPa at the exposed edges 105a, 105b of the glass core layer 102, such as at least about 150 MPa, at least about 200 MPa, at least about 250 MPa, at least about 300 MPa, at least about 350 MPa, at least about 400 MPa, at least about 450 MPa, or even at least about 500 MPa. In some embodiments, the compressive stress in the hydrogen-containing core zones 110a, 110b may include a compressive stress of about 100 MPa to about 500 MPa, such as about 150 MPa to about 450 MPa, about 150 MPa to about 400 MPa, about 200 MPa to about 400 MPa, about 200 MPa to about 350 MPa, about 200 MPa to about 300 MPa, or any sub-ranges formed from any of these endpoints.

In some embodiments, the core zone DOC may be at least about 5 μm, such as at least about 10 μm, about 15 μm, about 20 μm, about 25 μm, about 30 μm, or more. In some embodiments, the core zone DOC may be at about 5 μm to about 50 μm, such as about 5 μm to about 40 μm, about 5 μm to about 30 μm, about 5 μm to about 20 μm, about 5 μm to about 15 μm, about 5 μm to about 12 μm, about 5 μm to about 10 μm or any sub-ranges that may be formed from any of these endpoints. In some embodiments, the core zone DOC in each hydrogen-containing core zone 110a, 110b may be greater than or equal to the corresponding core zone penetration depth CZ_{PD1}, CZ_{PD2}. In some embodiments, the core zone DOC in each hydrogen-containing core zone 110a, 110b may be less than the corresponding core zone penetration depth CZ_{PD1}, CZ_{PD2}.

The laminated glass article 100 also contains a tensile stress region having a maximum central tension (CT), such that the forces within the laminated glass article 100 are balanced. This tensile stress region primarily lies within the central core zone 112 of the glass core layer 102. In embodiments, the regions of the glass core layer 102 that contain tensile stress are entirely within the central core zone 112, including when the regions of tensile stress within the glass core layer 102 are co-extensive with the central core zone 112.

In some embodiments, the maximum CT within the central core zone 112 may be at least about 10 MPa, such as at least about 15 MPa, about 20 MPa, about 30 MPa, about 40 MPa, about 50 MPa, about 60 MPa, about 70 MPa, about 80 MPa, about 90 MPa, about 100 MPa, about 110 MPa, about 120 MPa, about 130 MPa, about 140 MPa, about 150 MPa, or more. In some embodiments, the CT within the central core zone 112 may be about 10 MPa to about 150 MPa, such as about 20 MPa to about 150 MPa, about 30 MPa to about 150 MPa, about 40 MPa to about 150 MPa, about 40 MPa to about 150 MPa, about 40 MPa to about 140 MPa, about 40 MPa to about 130 MPa, about 40 MPa to about 120 MPa, about 40 MPa to about 110 MPa, about 40 MPa to about 100 MPa, about 40 MPa to about 90 MPa, or any sub-ranges formed from any of these endpoints.

As noted herein, it is believed that the compressive stress within the glass core layer 102, specifically the compressive stress within the hydrogen-containing core zones 110a, 110b of the glass core layer 102, is due to the diffusion of hydrogen-containing species into the glass core layer 102. Further, as noted herein, the hydrogen-containing species within the hydrogen-containing core zones 110a, 110b have a concentration gradient which decreases from a maximum value at or near the exposed edges 105a, 105b of the glass core layer 102 to the corresponding core zone penetration depths CZ_{PD1}, CZ_{PD2}.

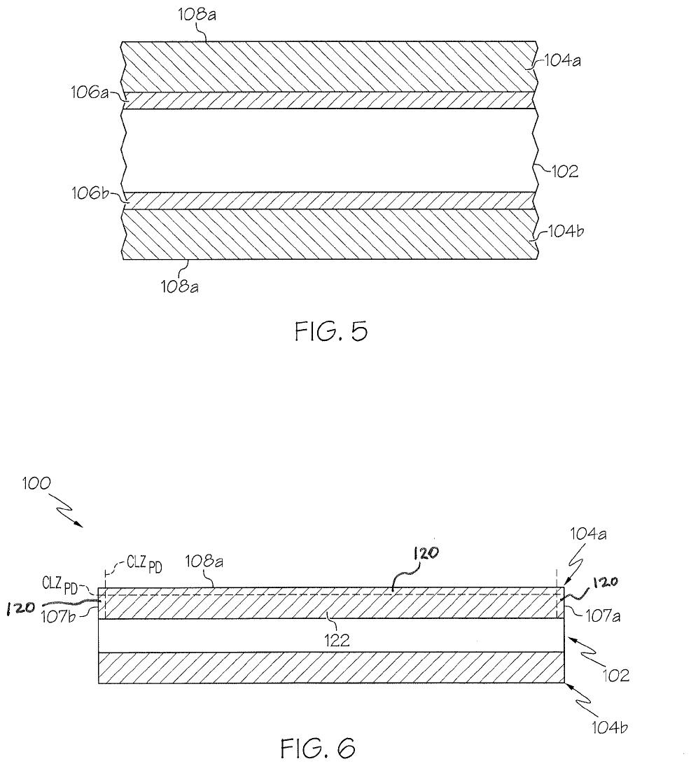

In some embodiments, the laminated glass article 100 may further comprise interface regions 106a, 106b at the interface between the glass core layer 102 and the glass clad layers 104a, 104b. Referring to FIG. 5 by way of example, an enlarged view of the interface between the glass core layer 102 and the glass clad layers 104a, 104b is schematically depicted. The interface regions 106a, 106b are formed when the glass core layer 102 and the glass clad layers 104a, 104b fuse together. The interface regions 106a, 106b are thin layers that consist of a mixture of the clad compositions forming the glass clad layers 104a, 104b and the core composition forming the glass core layer 102. For example, the interface regions 106a, 106b may comprise intermediate glass layers and/or diffusion layers formed at the interface of the glass core layer and the glass clad layer(s) (e.g., by diffusion of one or more components of the glass core and glass clad layers into the diffusion layer). In some embodiments, the laminated glass article 100 comprises a glass-glass laminate (e.g., an in situ fused multilayer glass-glass laminate) in which the interfaces between directly adjacent glass layers are glass-glass interfaces.

Referring now to FIG. 6, as noted herein, the composition of the glass core layer 102 may be specifically selected to promote the diffusion of hydrogen-containing species into the glass core layer 102 while the compositions of the glass clad layers 104a, 104b are selected to be less susceptible to the diffusion of hydrogen-containing species into the glass or even to discourage the diffusion of species of hydrogen into the glass, as will be described in further detail herein.

In some embodiments, such as embodiments where the glass core layer 102 is specifically selected to promote the diffusion of hydrogen-containing species into the glass core layer 102 while the compositions of the glass clad layers 104a, 104b are selected to be less susceptible to the diffusion of hydrogen-containing species, the hydrogen diffusivity of the glass core layer D_{HC} may be at least 10 times greater than the hydrogen diffusivity of the glass clad layers D_{HCL} (i.e., D_{HC}≥100*D_{HCL}). In some embodiments, the hydrogen diffusivity of the glass core layer D_{HC} is at least 100 times greater than the hydrogen diffusivity of the glass clad layers D_{HCL} (i.e., D_{HC}≥100*D_{HCL}). In some embodiments, the hydrogen diffusivity of the glass core layer D_{HC} is from about 100 times greater than the hydrogen diffusivity of the glass clad layers D_{HCL} to about 1000 times greater than the hydrogen diffusivity of the glass clad layers D_{HCL} (i.e., 100*D_{HCL}≤D_{HC}≤1000*D_{HCL}). In the embodiments described herein, the hydrogen diffusivity D_{H} of either the glass clad layers 104a, 104b or the glass core layer 102 may be determined according to the relationship:

$${D}_{H} = \frac{{x}^{2}}{t}$$

where D_{H} is the hydrogen diffusivity, X is the depth of penetration of the intentionally added hydrogen species (as determined from SIMS) after exposure to an environment containing water vapor, and t is the time of exposure of the glass article to the environment containing water vapor.

For example, in some embodiments, the glass core layer 102 of the laminated glass article 100 includes hydrogen-containing core zones (as described above with respect to FIG. 4) and the glass clad layers 104a, 104b include hydrogen-containing clad zones. A hydrogen-containing clad zone 120 in the glass clad layer 104a is schematically depicted in FIG. 6. In these embodiments, the hydrogen-containing clad zone 120 extends from the exposed clad edges 107a, 107b of the laminated glass article 100 and from the surface 108a of the laminated glass article 100 to a clad zone penetration depth CLZ_{PD} measured from the exposed clad edges 107a, 107b and/or the surface 108a. While FIG. 6 only depicts a hydrogen-containing clad zone 120 in the glass clad layer 104a, it should be understood that the glass clad layer 104b may also contain a similar hydrogen-containing clad zone.

In some embodiments where the glass clad layers 104a, 104b include hydrogen-containing clad zones, the clad zone penetration depths CLZ_{PD} of the hydrogen-containing clad zones may be less than the core zone penetrations depth CLZ_{PD} of the hydrogen containing core zones even after exposure to the same water vapor-containing environment. This is due to the glass clad layers 104a, 104b being formed from clad glass compositions that are less susceptible to the inward diffusion of hydrogen-containing species from an environment containing water vapor (i.e., clad glass compositions in which the hydrogen diffusivity of the resultant glass clad layers D_{HCL} is less than the hydrogen diffusivity of the glass core layer D_{HC}).

In some embodiments, the clad zone penetration depth CLZ_{PD} of the hydrogen-containing clad zone in the glass clad layer 104a may extend from the corresponding exposed clad edges 107a, 107b and/or the surface 108a of the glass clad layer 104a to a depth of less than about 5 μm. In some embodiments, the clad zone penetration depth CLZ_{PD} of the hydrogen-containing clad zone 120 may be less than about 2.5 μm, such as less than about 2 μm, less than about 1.5 μm, less than about 1 μm, less than about 0.5 μm, less than about 0.2 μm, less than about 0.1 μm, less than about 0.09 μm, or even less than about 0.09 μm.

Still referring to FIG. 6, the hydrogen-containing clad zone 120 comprises a hydrogen concentration that decreases from a maximum value proximate to (i.e., at or near) the exposed edge 107a, 107b of the glass clad layer 104a and the surface 108a of the glass clad layer 104a to the clad zone penetration depth CLZ_{PD}. The hydrogen concentration in the hydrogen-containing clad zone 120 is a minimum at the clad zone penetration depths CLZ_{PD}. Accordingly, it should be understood that the hydrogen-containing clad zone 120 comprises a hydrogen concentration gradient that decreases from a maximum value at or near the exposed edges 107a, 107b and/or the surface 108 to the corresponding clad zone penetration depth CLZ_{PD}.

In some of the embodiments described herein, the glass clad layer 104a of the laminated glass article further comprises a central clad zone 122 disposed between the hydrogen-containing clad zone 120 and the glass core layer 102. The central clad zone 122 is free of any hydrogen-containing species intentionally added to the laminated glass article 100 following formation of the laminated glass article 100, such as species of hydrogen diffused into the glass by exposing the laminated glass article 100 to environments containing water vapor. In embodiments, the concentration of hydrogen is substantially constant throughout the central clad zone 122.

Based on the foregoing, it should be understood that, in some embodiments described herein, the glass core layer 102 of the laminated glass articles 100 is formed from a glass composition which is more susceptible and amenable to the inward diffusion of hydrogen-containing species than glass composition from which the glass clad layers 104a, 104b are formed.

In some embodiments, the glass core layer 102 of the laminated glass article 100 is formed from a glass composition which includes constituents components selected to promote the diffusion of hydrogen-containing species, such that a laminated glass article including hydrogen-containing zones in the glass core layer 102 may be readily and efficiently formed. In some embodiments, the glass core layer 102 may have a composition that includes SiO₂, Al₂O₃, and P₂O₅. While not wishing to be bound by theory, it is believed that P₂O₅ may promote and/or enhance the diffusion of hydrogen-containing species into the glass core layer 102. In some embodiments, the glass core layer 102 may additionally include an alkali metal oxide, such as at least one of Li₂O, Na₂O, K₂O, Rb₂O, and Cs₂O. In some embodiments, glass core layer 102 may be substantially free, or free, of at least lithium. While not wishing to be bound by theory, it is believed that lithium in the glass core layer 102, such as Li₂O or the like, may inhibit the diffusion of hydrogen-containing species into the glass core layer 102.

In some embodiments, the glass core layer 102 may include any appropriate amount of SiO₂. SiO₂ is the largest constituent of the glass core layer and, as such, SiO₂ is the primary constituent of the glass network formed from the glass composition. If the concentration of SiO₂ in the glass composition is too high, the formability of the glass composition may be diminished as higher concentrations of SiO₂ increase the difficulty of melting the glass, which, in turn, adversely impacts the formability of the glass. In some embodiments, the glass composition of the glass core layer 102 may include SiO₂ in an amount of about 45 mol % to about 75 mol %, such as about 46 mol % to about 74 mol %, about 47 mol % to about 73 mol %, about 48 mol % to about 72 mol %, about 49 mol % to about 71 mol %, about 50 mol % to about 70 mol %, about 51 mol % to about 69 mol %, about 52 mol % to about 68 mol %, about 53 mol % to about 67 mol %, about 54 mol % to about 66 mol %, about 55 mol % to about 65 mol %, about 56 mol % to about 64 mol %, about 57 mol % to about 63 mol %, about 58 mol % to about 62 mol %, about 59 mol % to about 61 mol %, about 60 mol %, or any sub-ranges formed by any of these endpoints. In some embodiments, the glass-based substrate may include SiO₂ in an amount of about 55 mol % to about 69 mol %, such as about 57 mol % to about 63 mol %.

The glass core layer 102 may also include any appropriate amount of Al₂O₃. Al₂O₃ may serve as a glass network former, similar to SiO₂. Al₂O₃ may increase the viscosity of the glass composition due to its tetrahedral coordination in a glass melt formed from the glass composition, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes, such as the fusion forming process. The inclusion of Al₂O₃ in the glass core layer 102 prevents phase separation and reduces the number of non-bridging oxygens (NBOs) in the glass. Additionally, Al₂O₃ can improve the effectiveness of ion exchange should the laminated glass article 100 be strengthened by ion exchange in addition to the inward diffusion of hydrogen-containing species. In some embodiments, the glass core layer may include Al₂O₃ in an amount of about 3 mol % to about 20 mol %, such as about 4 mol % to about 19 mol %, about 5 mol % to about 18 mol %, about 6 mol % to about 17 mol %, about 7 mol % to about 16 mol %, about 8 mol % to about 15 mol %, about 9 mol % to about 14 mol %, about 10 mol % to about 13 mol %, about 11 mol % to about 12 mol %, or any sub-ranges formed by any of these endpoints. In some embodiments, the glass core layer 102 may include Al₂O₃ in an amount of about 5 mol % to about 18 mol %, such as about 7 mol % to about 17 mol %.

The glass core layer 102 may also include any amount of P₂O₅ sufficient to produce the desired hydrogen diffusivity. As noted herein, the incorporation of phosphorous in the glass core layer 102 may promote and/or enhance the diffusion of hydrogen-containing species into the glass core layer 102. In some embodiments, the glass core layer 102 may include P₂O₅ in an amount of about 4 mol % to about 15 mol %, such as about 5 mol % to about 14 mol %, about 6 mol % to about 13 mol %, about 7 mol % to about 12 mol %, about 8 mol % to about 11 mol %, about 9 mol % to about 10 mol %, or any sub-ranges formed by any of these endpoints. In some embodiments, the glass core layer 102 may include P₂O₅ in an amount of about 5 mol % to about 15 mol %, such as about 6 mol % to about 15 mol %, as about 5 mol % to about 10 mol %, about 6 mol % to about 10 mol %, or about 7 mol % to about 10 mol %.

The glass core layer 102 may include an alkali metal oxide in any appropriate amount. The sum of the alkali metal oxides (e.g., Li₂O, Na₂O, and K₂O as well as other alkali metal oxides including Cs₂O and Rb₂O) in the glass composition may be referred to as “R₂O”, and R₂O may be expressed in mol %. In some embodiments, the glass core layer 102 may be substantially free, or free, of lithium. In embodiments, the glass core layer 102 comprises R₂O in an amount greater than or equal to about 6 mol %, such as greater than or equal to about 7 mol %, greater than or equal to about 8 mol %, greater than or equal to about 9 mol %, greater than or equal to about 10 mol %, greater than or equal to about 11 mol %, greater than or equal to about 12 mol %, greater than or equal to about 13 mol %, greater than or equal to about 14 mol %, greater than or equal to about 15 mol %, greater than or equal to about 16 mol %, greater than or equal to about 17 mol %, greater than or equal to about 18 mol %, greater than or equal to about 19 mol %, greater than or equal to about 20 mol %, greater than or equal to about 21 mol %, greater than or equal to about 22 mol %, greater than or equal to about 23 mol %, or greater than or equal to about 24 mol %. In one or more embodiments, the glass core layer 102 comprises R₂O in an amount less than or equal to about 25 mol %, such as less than or equal to about 24 mol %, less than or equal to about 23 mol %, less than or equal to about 22 mol %, less than or equal to about 21 mol %, less than or equal to about 20 mol %, less than or equal to about 19 mol %, less than or equal to about 18 mol %, less than or equal to about 17 mol %, less than or equal to about 16 mol %, less than or equal to about 15 mol %, less than or equal to about 14 mol %, less than or equal to about 13 mol %, less than or equal to about 12 mol %, less than or equal to about 11 mol %, less than or equal to about 10 mol %, less than or equal to about 9 mol %, less than or equal to about 8 mol %, or less than or equal to about 7 mol %. It should be understood that, in embodiments, any of the above ranges may be combined with any other range. In some embodiments, the glass core layer 102 comprises R₂O in an amount from greater than or equal to about 6.0 mol % to less than or equal to about 25.0 mol %, such as from greater than or equal to about 7.0 mol % to less than or equal to about 24.0 mol %, from greater than or equal to about 8.0 mol % to less than or equal to about 23.0 mol %, from greater than or equal to about 9.0 mol % to less than or equal to about 22.0 mol %, from greater than or equal to about 10.0 mol % to less than or equal to about 21.0 mol %, from greater than or equal to about 11.0 mol % to less than or equal to about 20.0 mol %, from greater than or equal to about 12.0 mol % to less than or equal to about 19.0 mol %, from greater than or equal to about 13.0 mol % to less than or equal to about 18.0 mol %, from greater than or equal to about 14.0 mol % to less than or equal to about 17.0 mol %, or from greater than or equal to about 15.0 mol % to less than or equal to about 16.0 mol %, and all ranges and sub-ranges between the foregoing values.

In some embodiments, the alkali metal oxide may optionally include K₂O. K₂O, when included, encourages the diffusion of hydrogen-containing species, such as hydronium ions, into the glass core layer 102 upon exposure to an environment containing water vapor, as described further below. In embodiments where the glass core layer includes K₂O, K₂O may be included in an amount of about 2 mol % to about 25 mol %, such as about 5 mol % to about 24 mol %, about 7 mol % to about 23 mol %, about 8 mol % to about 22 mol %, about 9 mol % to about 21 mol %, about 10 mol % to about 20 mol %, about 11 mol % to about 19 mol %, about 12 mol % to about 18 mol %, about 13 mol % to about 17 mol %, about 14 mol % to about 16 mol %, or any sub-ranges formed from any of these endpoints. In some embodiments, the glass core layer may include K₂O in an amount of about 10 mol % to about 25 mol %, such as about 10 mol % to about 20 mol %, about 11 mol % to about 25 mol %, about 11 mol % to about 20 mol %, or about 15 mol % to about 20 mol %%, or any subranges formed from any of these endpoints.

The glass core layer 102 may optionally include Rb₂O in any appropriate amount. In some embodiments, the glass core layer may include Rb₂O in an amount of 0 mol % to about 10 mol %, such as about 1 mol % to about 9 mol %, about 2 mol % to about 8 mol %, about 3 mol % to about 7 mol %, about 4 mol % to about 6 mol %, about 5 mol %, or any sub-range formed from any of these endpoints.

The glass core layer 102 may optionally include Cs₂O in any appropriate amount. In some embodiments, the glass core layer may include Cs₂O in an amount of 0 mol % to about 10 mol %, such as about 1 mol % to about 9 mol %, about 2 mol % to about 8 mol %, about 3 mol % to about 7 mol %, about 4 mol % to about 6 mol %, about 5 mol %, or any sub-range formed from any of these endpoints.

In some embodiments, the glass core layer of the laminated glass article may have a composition including: about 45 mol % to about 75 mol % SiO₂, about 3 mol % to about 20 mol % Al₂O₃, about 6 mol % to about 15 mol % P₂O₅, and up to about 25 mol % K₂O.

In some embodiments, the glass core layer of the laminated glass article may have a composition including: about 45 mol % to about 75 mol % SiO₂, about 3 mol % to about 20 mol % Al₂O₃, about 4 mol % to about 15 mol % P₂O₅, and about 6 mol % to about 25 mol % K₂O.

In some embodiments, the glass core layer of the laminated glass article may have a composition including: about 55 mol % to about 69 mol % SiO₂, about 5 mol % to about 17 mol % Al₂O₃, about 6 mol % to about 10 mol % P₂O₅, and up to about 20 mol % K₂O.

In some embodiments, the glass core layer of the laminated glass article may have a composition including: about 55 mol % to about 69 mol % SiO₂, about 5 mol % to about 15 mol % Al₂O₃, about 5 mol % to about 10 mol % P₂O₅, and about 11 mol % to about 20 mol % K₂O.

In some embodiments, the glass core layer of the laminated glass article may have a composition including: about 58 mol % to about 63 mol % SiO₂, about 7 mol % to about 14 mol % Al₂O₃, about 7 mol % to about 10 mol % P₂O₅, and about 15 mol % to about 20 mol % K₂O.

As an alternative to the foregoing compositions, the glass core layer 102 of the laminated glass article 100 may be formed from the glass compositions disclosed in U.S. Pat. Nos. 9,156,724, 9,346,703, 9,682,885, 9,783,453, 9,815,733, 9,969,644, 9,975,803, and 10,017,412.

Specific glass compositions from which the glass core layer 102 may be formed include those compositions listed in Table 1. However, it should be understood that other glass compositions for the glass core layer 102 of the laminated glass article 100 are contemplated and possible.

TABLE 1
Example glass core layer compositions.

| Composition (mol %) | C1 | C2 |
|---|---|---|
| SiO₂ | 57.43 | 58.18 |
| Al₂O₃ | 16.50 | 15.32 |
| B₂O₃ | 0.00 | 0.00 |
| P₂O₅ | 6.54 | 6.55 |
| Na₂O | 16.65 | 16.51 |
| SnO₂ | 0.07 | 0.10 |
| K₂O | 0.00 | 2.28 |
| MgO | 2.81 | 1.07 |
| BaO | 0.00 | 0.00 |
| SrO | 0.00 | 0.00 |
| CaO | 0.00 | 0.00 |

As noted herein, in some embodiments the glass clad layers 104a, 104b of the laminated glass articles 100 are formed from a glass composition which is less susceptible to the inward diffusion of hydrogen-containing species than glass composition from which the glass core layer 102 is formed. In embodiments, the glass clad layers 104a, 104b may be formed from the glass compositions disclosed U.S. Pat. Nos. 7,851,394, 7,534,734, 9,802,857, 9,162,919, 8,598,056, and 7,833,919. In some embodiments, the glass clad layers 104a, 104b are formed from a glass composition that is free of alkali metal oxides, such as K₂O, Na₂O, Li₂O and the like. Specific glass compositions from which the glass clad layers 104a, 104b may be formed include those compositions listed in Tables 2A and 2B. However, it should be understood that other glass compositions for the glass clad layers 104a, 104b of the laminated glass article 100 are contemplated and possible.

TABLE 2A
Example glass clad layer compositions.

| Composition (mol %) | CL1 | CL2 | CL3 |
|---|---|---|---|
| SiO₂ | 67.50 | 69.69 | 69.59 |
| Al₂O₃ | 11.06 | 12.30 | 12.03 |
| B₂O₃ | 9.83 | 4.39 | 3.27 |
| P₂O₅ | 0.00 | 0.00 | 0.00 |
| Na₂O | 0.00 | 0.00 | 0.00 |
| SnO₂ | 0.08 | 0.08 | 0.08 |
| K₂O | 0.00 | 0.00 | 0.00 |
| MgO | 2.26 | 3.93 | 4.74 |
| BaO | 0.01 | 1.99 | 3.19 |
| SrO | 0.50 | 1.71 | 1.25 |
| CaO | 8.76 | 5.90 | 5.84 |

TABLE 2B
Example glass clad layer compositions.

| Composition (mol %) | CL4 | CL5 | CL6 |
|---|---|---|---|
| SiO₂ | 71.18 | 70.27 | 71.59 |
| Al₂O₃ | 12.50 | 12.79 | 12.43 |
| B₂O₃ | 2.54 | 2.08 | 0.72 |
| P₂O₅ | 0.00 | 0.00 | 0.00 |
| Na₂O | 0.00 | 0.00 | 0.00 |
| SnO₂ | 0.08 | 0.08 | 0.08 |
| K₂O | 0.00 | 0.00 | 0.00 |
| MgO | 3.57 | 4.03 | 5.01 |
| BaO | 3.43 | 3.13 | 3.36 |
| SrO | 1.41 | 0.93 | 1.47 |
| CaO | 5.28 | 6.69 | 5.33 |

In some additional embodiments, the composition of the glass clad layers 104a, 104b is specifically selected to promote the diffusion of hydrogen-containing species into the clad layers 104a, 104b. As is depicted in FIG. 6, in some embodiments, the glass clad layers 104a, 104b include hydrogen-containing clad zones. In these embodiments, the hydrogen-containing clad zone 120 extends from the exposed clad edges 107a, 107b of the laminated glass article 100 and from the surface 108a of the laminated glass article 100 to a clad zone penetration depth CLZ_{PD} measured from the exposed clad edges 107a, 107b and/or the surface 108a.

In such embodiments, the hydrogen-containing clad zone 120 contain species of hydrogen (also referred to herein as “hydrogen-containing species) that are diffused into the glass clad layers 104a, 104b by exposing the laminated glass article 100 to environments containing water vapor, as will be described in further detail herein. The composition of the glass clad layers 104a, 104b may be selected to promote the diffusion of hydrogen-containing species into the glass clad layers 104a, 104b.

In some embodiments, the clad zone penetration depth CLZ_{PD} of the hydrogen-containing clad zone 120 in the glass clad layers 104a, 104b may be greater than or equal to 2 μm, such as greater than or equal to about 2.5 μm or even greater than or equal to about 3 μm from the corresponding exposed clad edges 107a, 107b and/or the surface 108a of the glass clad layers 104a, 104b. In some embodiments, the clad zone penetration depth CLZ_{PD} of the hydrogen-containing clad zone 120 may be greater than about 5 μm, such as greater than about 10 μm, greater than about 15 μm, greater than about 20 μm, greater than about 25 μm, greater than about 30 μm, greater than about 35 μm, greater than about 40 μm, greater than about 45 μm, greater than about 50 μm, greater than about 55 μm, greater than about 60 μm, greater than about 65 μm, greater than about 70 μm, greater than about 75 μm, greater than about 80 μm, greater than about 85 μm, greater than about 90 μm, greater than about 95 μm, greater than about 100 μm, greater than about 105 μm, greater than about 110 μm, greater than about 115 μm, greater than about 120 μm, greater than about 125 μm, greater than about 130 μm, greater than about 135 μm, greater than about 140 μm, greater than about 145 μm, greater than about 150 μm, greater than about 155 μm, greater than about 160 μm, greater than about 165 μm, greater than about 170 μm, greater than about 175 μm, greater than about 180 μm, greater than about 185 μm, greater than about 190 μm, greater than about 195 μm, greater than about 200 μm, or more. In embodiments, the clad zone penetration depth CLZ_{PD} of the hydrogen-containing clad zone 120 may be 2.5 μm or even about 3 μm to about 205 μm, such as about 5 μm to about 200 μm, about 15 μm to about 195 μm, about 20 μm to about 190 μm, about 25 μm to about 185 μm, about 30 μm to about 180 μm, about 35 μm to about 175 μm, about 40 μm to about 170 μm, about 45 μm to about 165 μm, about 50 μm to about 160 μm, about 55 μm to about 155 μm, about 60 μm to about 150 μm, about 65 μm to about 145 μm, about 70 μm to about 140 μm, about 75 μm to about 135 μm, about 80 μm to about 130 μm, about 85 μm to about 125 μm, about 90 μm to about 120 μm, about 95 μm to about 115 μm, about 100 μm to about 110 μm, or any sub-ranges formed by any of these endpoints. In general, the clad zone penetration depth CLZ_{PD} of hydrogen-containing clad zone 120 are greater than the hydrogen penetration depth due to exposure of the laminated glass article to the ambient environment.

In the embodiments described herein, the clad zone penetration depth CLZ_{PD} of the hydrogen-containing clad zone 120 and the hydrogen concentration of the hydrogen-containing clad zone 120 may be measured by secondary ion mass spectrometry (SIMS) as noted herein.

Still referring to FIG. 6, each of the hydrogen-containing clad zones 120 comprises a hydrogen concentration that decreases from a maximum value proximate (i.e., at or near) the corresponding exposed clad edges 107a, 107b and/or the surface 108a of the glass clad layers 104a, 104b to the corresponding clad zone penetration depth CLZ_{PD} in a direction toward the center of the glass clad layers 104a, 104b (e.g., indicated as C_{L} in FIG. 4) or into the thickness of the glass clad layers 104a, 104b. The hydrogen concentration is a minimum at the exposed clad edges 107a, 107b and/or the surface 108a. Accordingly, it should be understood that each of the hydrogen-containing clad zones 120 may comprise a hydrogen concentration gradient which decreases from a maximum value at or near the corresponding exposed clad edges 107a, 107b and/or the surface 108a to the corresponding clad zone penetration depth CLZ_{PD}.

As noted herein, the hydrogen-containing species in the hydrogen-containing clad zones 120 create compressive stress in the glass of the glass clad layers 104a, 104b within the hydrogen-containing clad zones 120. Without wishing to be bound by any theory, it is believe that the compressive stress in the hydrogen-containing clad zone 120 is the result of the diffusion of hydrogen and/or hydrogen-containing species, such as H₂O, H₃O⁺ and/or H⁺ or the like, into the glass clad layers 104a, 104b. These hydrogen-containing species react with the glass network to cause a volumetric expansion which, in turn, develops compressive stress in the glass. The compressive stress generally varies with the concentration of hydrogen in the hydrogen-containing clad zone 120. In embodiments, the compressive stress is a maximum at or near the exposed clad edges 107a, 107b and/or the surface 108a of the respective hydrogen-containing clad zone 120 (i.e., where the concentration of hydrogen is a maximum) and decreases from the maximum with increasing distance from the maximum towards the respective clad zone penetration depth CLZ_{PD}. In general, the compressive stress is a minimum at or adjacent to the respective clad zone penetration depth CLZ_{PD} (i.e., where the concentration of hydrogen is a minimum). As such, it should be understood that the regions of the glass clad layers 104a, 104b that contain the most compressive stress are primarily located within the hydrogen-containing clad zone 120. While CTE mismatch may produce some compressive stress in the clad layers 104a, 104b, the introduction of the hydrogen-containing clad zone 120 may further contribute to compressive stress at or near the surface of the glass article.

In the embodiments described herein, the compressive stress in the hydrogen-containing clad zone 120 may extend to a clad zone depth of compression (i.e., a clad zone DOC). As used herein, the phrases “clad zone depth of compression” and “clad zone DOC” refer to the depth or distance from the respective exposed clad edges 107a, 107b and/or the surface 108a of the glass clad layers 104a, 104b at which the stress in the glass-based article changes from the elevated compression level caused by the hydrogen infusion to the “baseline” level of compressive stress formed by, for example, CTE mismatch of the glass core layer 102 and the clad layers 104a, 104b.

In some embodiments, the compressive stress in the hydrogen-containing clad zone 120 may include a compressive stress of at least about 100 MPa at the exposed clad edges 107a, 107b and/or the surface 108a of the glass clad layers 104a, 104b, such as at least about 150 MPa, at least about 200 MPa, at least about 250 MPa, at least about 300 MPa, at least about 350 MPa, at least about 400 MPa, at least about 450 MPa, or even at least about 500 MPa. In some embodiments, the compressive stress in the hydrogen-containing clad zone 120 may include a compressive stress of about 100 MPa to about 500 MPa, such as about 150 MPa to about 450 MPa, about 150 MPa to about 400 MPa, about 200 MPa to about 400 MPa, about 200 MPa to about 350 MPa, about 200 MPa to about 300 MPa, or any sub-ranges formed from any of these endpoints. In some embodiments, the compressive stress in the hydrogen-containing clad zone 120 may be greater than the compressive stress in the central clad zone 122. For example, the difference in compressive stress between the central clad zone 122 and the hydrogen-containing clad zone 120 may be at least about 150 MPa, at least about 200 MPa, at least about 250 MPa, at least about 300 MPa, at least about 350 MPa, at least about 400 MPa, at least about 450 MPa, or even at least about 500 MPa.

In some embodiments, the clad zone DOC may be at least about 5 μm, such as at least about 10 μm, about 15 μm, about 20 μm, about 25 μm, about 30 μm, or more. In some embodiments, the clad zone DOC may be at about 5 μm to about 50 μm, such as about 5 μm to about 40 μm, about 5 μm to about 30 μm, about 5 μm to about 20 μm, about 5 μm to about 15 μm, about 5 μm to about 12 μm, about 5 μm to about 10 μm or any sub-ranges that may be formed from any of these endpoints.

As noted herein, it is believed that the compressive stress within the glass clad layers 104a, 104b, specifically the compressive stress within the hydrogen-containing clad zone 120 of the glass clad layers 104a, 104b, is due to the diffusion of hydrogen-containing species into the glass clad layers 104a, 104b. Further, as noted herein, the hydrogen-containing species within the hydrogen-containing clad zone 120 have a concentration gradient which decreases from a maximum value at or near the exposed clad edges 107a, 107b and/or the surface 108a of the glass clad layers 104a, 104b to the corresponding clad zone penetration depth CLZ_{PD}.

In some embodiments, the glass clad layers 104a, 104b of the laminated glass article 100 are formed from a glass composition which includes constituents components selected to promote the diffusion of hydrogen-containing species, such that a laminated glass article including hydrogen-containing zones in the glass clad layers 104a, 104b may be readily and efficiently formed. In some embodiments, the glass clad layers 104a, 104b may have a composition that includes SiO₂, Al₂O₃, and Na₂O. While not wishing to be bound by theory, it is believed that Na₂O may contribute to a relatively low CTE, which may be desirable for utilization as the clad layers 104a, 104b when CTE mismatch is utilized to form stress in a laminated article. In some embodiments, the glass clad layers 104a, 104b may additionally include additional alkali metal oxides, such as at least one of Li₂O, K₂O, Rb₂O, and Cs₂O. The glass composition may additionally, in some embodiments, include P₂O₅ such as in amounts less than or equal to about 8 mol. %. In some embodiments, glass clad layers 104a, 104b may be substantially free, or free, of at least lithium. While not wishing to be bound by theory, it is believed that lithium in the glass clad layers 104a, 104b, such as Li₂O or the like, may inhibit the diffusion of hydrogen-containing species into the glass clad layers 104a, 104b.

In some embodiments, the glass clad layers 104a, 104b may include any appropriate amount of SiO₂. SiO₂ is the largest constituent of the glass clad layers 104a, 104b and, as such, SiO₂ is the primary constituent of the glass network formed from the glass composition. If the concentration of SiO₂ in the glass composition is too high, the formability of the glass composition may be diminished as higher concentrations of SiO₂ increase the difficulty of melting the glass, which, in turn, adversely impacts the formability of the glass. In some embodiments, the glass composition of the glass clad layers 104a, 104b may include SiO₂ in an amount of about 45 mol % to about 80 mol %, such as at least about 46 mol %, at least about 47 mol %, at least about 48 mol %, at least about 49 mol %, at least about 50 mol %, at least about 51 mol %, at least about 52 mol %, at least about 53 mol %, at least about 54 mol %, at least about 55 mol %, at least about 56 mol %, at least about 57 mol %, at least about 58 mol %, at least about 59 mol %, at least about 60 mol %, at least about 61 mol %, at least about 62 mol %, at least about 63 mol %, at least about 64 mol %, at least about 65 mol %, at least about 66 mol %, at least about 67 mol %, at least about 68 mol %, at least about 69 mol %, at least about 70 mol %, at least about 71 mol %, at least about 72 mol %, at least about 73 mol %, at least about 74 mol %, at least about 75 mol %, at least about 76 mol %, at least about 77 mol %, at least about 78 mol %, or at least about 79 mol %, and less than or equal to about 80 mol %. In additional embodiments, the glass composition of the glass clad layers 104a, 104b may include SiO₂ in an amount of at least about 45 mol % and less than or equal to about 46, less than or equal to about 47 mol %, less than or equal to about 48 mol %, less than or equal to about 49 mol %, less than or equal to about 50 mol %, less than or equal to about 51 mol %, less than or equal to about 52 mol %, less than or equal to about 53 mol %, less than or equal to about 54 mol %, less than or equal to about 55 mol %, less than or equal to about 56 mol %, less than or equal to about 57 mol %, less than or equal to about 58 mol %, less than or equal to about 59 mol %, less than or equal to about 60 mol %, less than or equal to about 61 mol %, less than or equal to about 62 mol %, less than or equal to about 63 mol %, less than or equal to about 64 mol %, less than or equal to about 65 mol %, less than or equal to about 66 mol %, less than or equal to about 67 mol %, less than or equal to about 68 mol %, less than or equal to about 69 mol %, less than or equal to about 70 mol %, less than or equal to about 71 mol %, less than or equal to about 72 mol %, less than or equal to about 73 mol %, less than or equal to about 74 mol %, less than or equal to about 75 mol %, less than or equal to about 76 mol %, less than or equal to about 77 mol %, less than or equal to about 78 mol %, or less than or equal to about 79 mol %. In some embodiments, the glass clad layers 104a, 104b may include SiO₂ in an amount of about 60 mol % to about 70 mol %.

The glass clad layers 104a, 104b may also include any appropriate amount of Al₂O₃. Al₂O₃ may serve as a glass network former, similar to SiO₂. Al₂O₃ may increase the viscosity of the glass composition due to its tetrahedral coordination in a glass melt formed from the glass composition, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes, such as the fusion forming process. The inclusion of Al₂O₃ in the glass clad layers 104a, 104b prevents phase separation and reduces the number of non-bridging oxygens (NBOs) in the glass. Additionally, Al₂O₃ can improve the effectiveness of ion exchange should the laminated glass article 100 be strengthened by ion exchange in addition to the inward diffusion of hydrogen-containing species.

In some embodiments, the glass clad layers 104a, 104b may include Al₂O₃ in an amount of about 3 mol % to about 20 mol %, such as about 10 mol % to about 15 mol %. For example, the glass clad layers 104a, 104b may include Al₂O₃ in an amount of at least 3 mol % and less than or equal to about 4 mol %, less than or equal to about 5 mol %, less than or equal to about 6 mol %, less than or equal to about 7 mol %, less than or equal to about 8 mol %, less than or equal to about 9 mol %, less than or equal to about 10 mol %, less than or equal to about 11 mol %, less than or equal to about 12 mol %, less than or equal to about 13 mol %, less than or equal to about 14 mol %, less than or equal to about 15 mol %, less than or equal to about 16 mol %, less than or equal to about 17 mol %, less than or equal to about 18 mol %, or less than or equal to about 19 mol %. In additional embodiments, the glass clad layers 104a, 104b may include Al₂O₃ in an amount of at least about 4 mol %, at least about 5 mol %, at least about 6 mol %, at least about 7 mol %, at least about 8 mol %, at least about 9 mol %, at least about 10 mol %, at least about 11 mol %, at least about 12 mol %, at least about 13 mol %, at least about 14 mol %, at least about 15 mol %, at least about 16 mol %, at least about 17 mol %, at least about 18 mol %, or at least about 19 mol %, and less than or equal to about 20 mol %.

The glass clad layers 104a, 104b may also include any amount of P₂O₅ sufficient to produce the desired hydrogen diffusivity. As noted herein, the incorporation of phosphorous in the glass clad layers 104a, 104b may promote and/or enhance the diffusion of hydrogen-containing species into the glass clad layers 104a, 104b. In some embodiments, the glass clad layers 104a, 104b may include P₂O₅ in an amount of about 0 mol % to about 8 mol %, such as about 2 mol % to about 6 mol %. In some embodiments, the glass clad layers 104a, 104b may include P₂O₅ in an amount of less than or equal to 8 mol %, less than or equal to about 7 mol %, less than or equal to about 6 mol %, less than or equal to about 5 mol %, less than or equal to about 4 mol %, less than or equal to about 3 mol %, less than or equal to about 2 mol %, or less than or equal to about 1 mol %.

The glass clad layers 104a, 104b may include an alkali metal oxide in any appropriate amount. The sum of the alkali metal oxides (e.g., Li₂O, Na₂O, and K₂O as well as other alkali metal oxides including Cs₂O and Rb₂O) in the glass composition may be referred to as “R₂O”, and R₂O may be expressed in mol %. In some embodiments, the glass clad layers 104a, 104b may be substantially free, or free, of lithium. In embodiments, the glass clad layers 104a, 104b comprises R₂O in an amount greater than or equal to about 6 mol %, such as greater than or equal to about 7 mol %, greater than or equal to about 8 mol %, greater than or equal to about 9 mol %, greater than or equal to about 10 mol %, greater than or equal to about 11 mol %, greater than or equal to about 12 mol %, greater than or equal to about 13 mol %, greater than or equal to about 14 mol %, greater than or equal to about 15 mol %, greater than or equal to about 16 mol %, greater than or equal to about 17 mol %, greater than or equal to about 18 mol %, greater than or equal to about 19 mol %, greater than or equal to about 20 mol %, greater than or equal to about 21 mol %, greater than or equal to about 22 mol %, greater than or equal to about 23 mol %, or greater than or equal to about 24 mol %. In one or more embodiments, the glass clad layers 104a, 104b comprises R₂O in an amount less than or equal to about 25 mol %, such as less than or equal to about 24 mol %, less than or equal to about 23 mol %, less than or equal to about 22 mol %, less than or equal to about 21 mol %, less than or equal to about 20 mol %, less than or equal to about 19 mol %, less than or equal to about 18 mol %, less than or equal to about 17 mol %, less than or equal to about 16 mol %, less than or equal to about 15 mol %, less than or equal to about 14 mol %, less than or equal to about 13 mol %, less than or equal to about 12 mol %, less than or equal to about 11 mol %, less than or equal to about 10 mol %, less than or equal to about 9 mol %, less than or equal to about 8 mol %, or less than or equal to about 7 mol %. It should be understood that, in embodiments, any of the above ranges may be combined with any other range. In some embodiments, the glass clad layers 104a, 104b comprises R₂O in an amount from greater than or equal to about 6.0 mol % to less than or equal to about 25.0 mol %, such as from greater than or equal to about 7.0 mol % to less than or equal to about 24.0 mol %, from greater than or equal to about 8.0 mol % to less than or equal to about 23.0 mol %, from greater than or equal to about 9.0 mol % to less than or equal to about 22.0 mol %, from greater than or equal to about 10.0 mol % to less than or equal to about 21.0 mol %, from greater than or equal to about 11.0 mol % to less than or equal to about 20.0 mol %, from greater than or equal to about 12.0 mol % to less than or equal to about 19.0 mol %, from greater than or equal to about 13.0 mol % to less than or equal to about 18.0 mol %, from greater than or equal to about 14.0 mol % to less than or equal to about 17.0 mol %, or from greater than or equal to about 15.0 mol % to less than or equal to about 16.0 mol %, and all ranges and sub-ranges between the foregoing values.

In some embodiments, the clad layers 104a, 104b may include Na₂O. Na₂O in relatively great amounts may contribute to a lower CTE. In one or more embodiments, the glass clad layers 104a, 104b may include Na₂O in an amount of about 1 mol % to about 20 mol %. For example, the glass clad layers 104a, 104b may include Na₂O in an amount of at least about 1 mol % and less than or equal to about 2 mol %, less than or equal to about 3 mol %, less than or equal to about 4 mol %, less than or equal to about 5 mol %, less than or equal to about 6 mol %, less than or equal to about 7 mol %, less than or equal to about 8 mol %, less than or equal to about 9 mol %, less than or equal to about 10 mol %, less than or equal to about 11 mol %, less than or equal to about 12 mol %, less than or equal to about 13 mol %, less than or equal to about 14 mol %, less than or equal to about 15 mol %, less than or equal to about 16 mol %, less than or equal to about 17 mol %, less than or equal to about 18 mol %, or less than or equal to about 19 mol %. In additional embodiments, the glass clad layers 104a, 104b may include Na₂O in an amount of at least about 2 mol %, at least about 3 mol %, at least about 4 mol %, at least about 5 mol %, at least about 6 mol %, at least about 7 mol %, at least about 8 mol %, at least about 9 mol %, at least about 10 mol %, at least about 11 mol %, at least about 12 mol %, at least about 13 mol %, at least about 14 mol %, at least about 15 mol %, at least about 16 mol %, at least about 17 mol %, at least about 18 mol %, at least about 19 mol %, and less than or equal to about 20 mol %.

In some embodiments, the clad layers 104a, 104b may optionally include K₂O. K₂O, when included, encourages the diffusion of hydrogen-containing species, such as hydronium ions, into the glass clad layers 104a, 104b upon exposure to an environment containing water vapor, as described further below. In embodiments where the glass clad layers 104a, 104b include K₂O, K₂O may be included in an amount of about 2 mol % to about 25 mol %, such as about 5 mol % to about 24 mol %, about 7 mol % to about 23 mol %, about 8 mol % to about 22 mol %, about 9 mol % to about 21 mol %, about 10 mol % to about 20 mol %, about 11 mol % to about 19 mol %, about 12 mol % to about 18 mol %, about 13 mol % to about 17 mol %, about 14 mol % to about 16 mol %, or any sub-ranges formed from any of these endpoints. In some embodiments, the glass clad layers 104a, 104b may include K₂O in an amount of about 10 mol % to about 25 mol %, such as about 10 mol % to about 20 mol %, about 11 mol % to about 25 mol %, about 11 mol % to about 20 mol %, or about 15 mol % to about 20 mol %%, or any subranges formed from any of these endpoints.

Specific glass compositions from which the glass clad layers 104a, 104b may be formed include those compositions listed in Example 4. Contemplated herein are glass compositions which include one, several, or all of the constituents of the glass compositions of Example 4 in ranges of +/−1 mol %, +/−2 mol %, +/−3 mol %, +/−4 mol %, +/−5 mol %, +/−6 mol %, +/−17 mol %, +/−8 mol %, +/−9 mol %, or +/−10 mol % for each selected glass constituent. However, it should be understood that other glass compositions for the glass clad layers 104a, 104b of the laminated glass article 100 are contemplated and possible.

According to additional embodiments, the glass compositions described herein as having propensity to from hydrogen-containing zones may from glass-based articles, such as glass sheets, which need not include a laminated geometry. For example, a glass sheet or other article may be formed from the glass compositions described herein. For example, a representative cross-section of a glass-based article 900 according to some embodiments is depicted in FIG. 13. The glass-based article 900 has a thickness t that extends between a first surface 910 and a second surface 912. A first compressive stress layer 920 extends from the first surface 910 to a first depth of compression, where the first depth of compression has a depth d₁ measured from the first surface 910 into the glass-based article 900. A second compressive stress layer 922 extends from the second surface 912 to a second depth of compression, where the second depth of compression has a depth d₂ measured from the second surface 912 into the glass-based article 900. A tensile stress region 930 is present between the first depth of compression and the second depth of compression. In embodiments, the first depth of compression d₁ may be substantially equivalent or equivalent to the second depth of compression d₂.

In some embodiments, the compressive stress layer of the glass-based article 900 may include a compressive stress of greater than or equal to 10 MPa, such as greater than or equal to 20 MPa, greater than or equal to 30 MPa, greater than or equal to 40 MPa, greater than or equal to 50 MPa, greater than or equal to 60 MPa, greater than or equal to 70 MPa, greater than or equal to 80 MPa, greater than or equal to 90 MPa, greater than or equal to 100 MPa, greater than or equal to 110 MPa, greater than or equal to 120 MPa, greater than or equal to 130 MPa, greater than or equal to 140 MPa, greater than or equal to 145 MPa, greater than or equal to 150 MPa, greater than or equal to 160 MPa, greater than or equal to 170 MPa, greater than or equal to 180 MPa, greater than or equal to 190 MPa, greater than or equal to 200 MPa, greater than or equal to 210 MPa, greater than or equal to 220 MPa, greater than or equal to 230 MPa, greater than or equal to 240 MPa, greater than or equal to 250 MPa, greater than or equal to 260 MPa, greater than or equal to 270 MPa, greater than or equal to 280 MPa, greater than or equal to 290 MPa, greater than or equal to 300 MPa, greater than or equal to 310 MPa, greater than or equal to 320 MPa, greater than or equal to 330 MPa, greater than or equal to 340 MPa, greater than or equal to 350 MPa, greater than or equal to 360 MPa, greater than or equal to 370 MPa, greater than or equal to 380 MPa, greater than or equal to 390 MPa, greater than or equal to 400 MPa, greater than or equal to 410 MPa, greater than or equal to 420 MPa, greater than or equal to 430 MPa, greater than or equal to 440 MPa, greater than or equal to 450 MPa, or more. In some embodiments, the compressive stress layer may include a compressive stress of from greater than or equal to 10 MPa to less than or equal to 500 MPa, such as from greater than or equal to 20 MPa to less than or equal to 490 MPa, from greater than or equal to 20 MPa to less than or equal to 480 MPa, from greater than or equal to 30 MPa to less than or equal to 470 MPa, from greater than or equal to 40 MPa to less than or equal to 460 MPa, from greater than or equal to 50 MPa to less than or equal to 450 MPa, from greater than or equal to 60 MPa to less than or equal to 440 MPa, from greater than or equal to 70 MPa to less than or equal to 430 MPa, from greater than or equal to 80 MPa to less than or equal to 420 MPa, from greater than or equal to 90 MPa to less than or equal to 410 MPa, from greater than or equal to 100 MPa to less than or equal to 400 MPa, from greater than or equal to 110 MPa to less than or equal to 390 MPa, from greater than or equal to 120 MPa to less than or equal to 380 MPa, from greater than or equal to 130 MPa to less than or equal to 370 MPa, from greater than or equal to 140 MPa to less than or equal to 360 MPa, from greater than or equal to 150 MPa to less than or equal to 350 MPa, from greater than or equal to 160 MPa to less than or equal to 340 MPa, from greater than or equal to 170 MPa to less than or equal to 330 MPa, from greater than or equal to 180 MPa to less than or equal to 320 MPa, from greater than or equal to 190 MPa to less than or equal to 310 MPa, from greater than or equal to 200 MPa to less than or equal to 300 MPa, from greater than or equal to 210 MPa to less than or equal to 290 MPa, from greater than or equal to 220 MPa to less than or equal to 280 MPa, from greater than or equal to 230 MPa to less than or equal to 270 MPa, from greater than or equal to 240 MPa to less than or equal to 260 MPa, 250 MPa, or any sub-ranges formed from any of these endpoints.

In some embodiments, the DOC of the compressive stress layer of the glass-based article 900 may be greater than or equal to 5 μm, such as greater than or equal to 7 μm, greater than or equal to 10 μm, greater than or equal to 15 μm, greater than or equal to 20 μm, greater than or equal to 25 μm, greater than or equal to 30 μm, greater than or equal to 35 μm, greater than or equal to 40 μm, greater than or equal to 45 μm, greater than or equal to 50 μm, greater than or equal to 55 μm, greater than or equal to 60 μm, greater than or equal to 65 μm, greater than or equal to 70 μm, greater than or equal to 75 μm, greater than or equal to 80 μm, greater than or equal to 85 μm, greater than or equal to 90 μm, greater than or equal to 95 μm, greater than or equal to 100 μm, greater than or equal to 105 μm, greater than or equal to 110 μm, greater than or equal to 115 μm, greater than or equal to 120 μm, greater than or equal to 125 μm, greater than or equal to 130 μm, greater than or equal to 135 μm, greater than or equal to 140 μm, greater than or equal to 145 μm, greater than or equal to 150 μm, greater than or equal to 155 μm, greater than or equal to 160 μm, greater than or equal to 165 μm, greater than or equal to 170 μm, greater than or equal to 175 μm, greater than or equal to 180 μm, greater than or equal to 185 μm, greater than or equal to 190 μm, greater than or equal to 195 μm, or more. In some embodiments, the DOC of the compressive stress layer may be from greater than or equal to 5 μm to less than or equal to 200 μm, such as from greater than or equal to 7 μm to less than or equal to 195 μm, from greater than or equal to 10 μm to less than or equal to 190 μm, from greater than or equal to 15 μm to less than or equal to 185 μm, from greater than or equal to 20 μm to less than or equal to 180 μm, from greater than or equal to 25 μm to less than or equal to 175 μm, from greater than or equal to 30 μm to less than or equal to 170 μm, from greater than or equal to 35 μm to less than or equal to 165 μm, from greater than or equal to 40 μm to less than or equal to 160 μm, from greater than or equal to 45 μm to less than or equal to 155 μm, from greater than or equal to 50 μm to less than or equal to 150 μm, from greater than or equal to 55 μm to less than or equal to 145 μm, from greater than or equal to 60 μm to less than or equal to 140 μm, from greater than or equal to 65 μm to less than or equal to 135 μm, from greater than or equal to 70 μm to less than or equal to 130 μm, from greater than or equal to 75 μm to less than or equal to 125 μm, from greater than or equal to 80 μm to less than or equal to 120 μm, from greater than or equal to 85 μm to less than or equal to 115 μm, from greater than or equal to 90 μm to less than or equal to 110 μm, 100 μm, or any sub-ranges that may be formed from any of these endpoints.

In some embodiments, the glass-based articles 900 may have a DOC greater than or equal to 0.05t, wherein t is the thickness of the glass-based article 900, such as greater than or equal to 0.06t, greater than or equal to 0.07t, greater than or equal to 0.08t, greater than or equal to 0.09t, greater than or equal to 0.10t, greater than or equal to 0.11t, greater than or equal to 0.12t, greater than or equal to 0.13t, greater than or equal to 0.14t, greater than or equal to 0.15t, greater than or equal to 0.16t, greater than or equal to 0.17t, greater than or equal to 0.18t, greater than or equal to 0.19t, or more. In some embodiments, the glass-based articles 900 may have a DOC from greater than or equal to 0.05t to less than or equal to 0.20t, such as from greater than or equal to 0.06t to less than or equal to 0.19t, from greater than or equal to 0.07t to less than or equal to 0.18t, from greater than or equal to 0.08t to less than or equal to 0.17t, from greater than or equal to 0.09t to less than or equal to 0.16t, from greater than or equal to 0.10t to less than or equal to 0.15t, from greater than or equal to 0.11t to less than or equal to 0.14t, from greater than or equal to 0.12t to less than or equal to 0.13t, or any sub-ranges formed from any of these endpoints.

In some embodiments, the maximum central tension (CT) of the glass-based article 900 may be greater than or equal to 10 MPa, such as greater than or equal to 11 MPa, greater than or equal to 12 MPa, greater than or equal to 13 MPa, greater than or equal to 14 MPa, greater than or equal to 15 MPa, greater than or equal to 16 MPa, greater than or equal to 17 MPa, greater than or equal to 18 MPa, greater than or equal to 19 MPa, greater than or equal to 20 MPa, greater than or equal to 22 MPa, greater than or equal to 24 MPa, greater than or equal to 26 MPa, greater than or equal to 28 MPa, greater than or equal to 30 MPa, greater than or equal to 32 MPa, or more. In some embodiments, the CT of the glass-based article 900 may be from greater than or equal to 10 MPa to less than or equal to 35 MPa, such as from greater than or equal to 11 MPa to less than or equal to 34 MPa, from greater than or equal to 12 MPa to less than or equal to 33 MPa, from greater than or equal to 13 MPa to less than or equal to 32 MPa, from greater than or equal to 14 MPa to less than or equal to 32 MPa, from greater than or equal to 15 MPa to less than or equal to 31 MPa, from greater than or equal to 16 MPa to less than or equal to 30 MPa, from greater than or equal to 17 MPa to less than or equal to 28 MPa, from greater than or equal to 18 MPa to less than or equal to 26 MPa, from greater than or equal to 19 MPa to less than or equal to 24 MPa, from greater than or equal to 20 MPa to less than or equal to 22 MPa, or any sub-ranges formed from any of these endpoints.

The hydrogen-containing layer of the glass-based articles 900 may have a depth of layer (DOL) greater than 5 μm. In some embodiments, the depth of layer may be greater than or equal to 10 μm, such as greater than or equal to 15 μm, greater than or equal to 20 μm, greater than or equal to 25 μm, greater than or equal to 30 μm, greater than or equal to 35 μm, greater than or equal to 40 μm, greater than or equal to 45 μm, greater than or equal to 50 μm, greater than or equal to 55 μm, greater than or equal to 60 μm, greater than or equal to 65 μm, greater than or equal to 70 μm, greater than or equal to 75 μm, greater than or equal to 80 μm, greater than or equal to 85 μm, greater than or equal to 90 μm, greater than or equal to 95 μm, greater than or equal to 100 μm, greater than or equal to 105 μm, greater than or equal to 110 μm, greater than or equal to 115 μm, greater than or equal to 120 μm, greater than or equal to 125 μm, greater than or equal to 130 μm, greater than or equal to 135 μm, greater than or equal to 140 μm, greater than or equal to 145 μm, greater than or equal to 150 μm, greater than or equal to 155 μm, greater than or equal to 160 μm, greater than or equal to 165 μm, greater than or equal to 170 μm, greater than or equal to 175 μm, greater than or equal to 180 μm, greater than or equal to 185 μm, greater than or equal to 190 μm, greater than or equal to 195 μm, greater than or equal to 200 μm, or more. In some embodiments, the depth of layer may be from greater than 5 μm to less than or equal to 205 μm, such as from greater than or equal to 10 μm to less than or equal to 200 μm, from greater than or equal to 15 μm to less than or equal to 200 μm, from greater than or equal to 20 μm to less than or equal to 195 μm, from greater than or equal to 25 μm to less than or equal to 190 μm, from greater than or equal to 30 μm to less than or equal to 185 μm, from greater than or equal to 35 μm to less than or equal to 180 μm, from greater than or equal to 40 μm to less than or equal to 175 μm, from greater than or equal to 45 μm to less than or equal to 170 μm, from greater than or equal to 50 μm to less than or equal to 165 μm, from greater than or equal to 55 μm to less than or equal to 160 μm, from greater than or equal to 60 μm to less than or equal to 155 μm, from greater than or equal to 65 μm to less than or equal to 150 μm, from greater than or equal to 70 μm to less than or equal to 145 μm, from greater than or equal to 75 μm to less than or equal to 140 μm, from greater than or equal to 80 μm to less than or equal to 135 μm, from greater than or equal to 85 μm to less than or equal to 130 μm, from greater than or equal to 90 μm to less than or equal to 125 μm, from greater than or equal to 95 μm to less than or equal to 120 μm, from greater than or equal to 100 μm to less than or equal to 115 μm, from greater than or equal to 105 μm to less than or equal to 110 μm, or any sub-ranges formed by any of these endpoints. In general, the depth of layer exhibited by the glass-based articles 900 is greater than the depth of layer that may be produced by exposure to the ambient environment.

The hydrogen-containing layer of the glass-based articles 900 may have a depth of layer (DOL) greater than 0.005t, wherein t is the thickness of the glass-based article. In some embodiments, the depth of layer may be greater than or equal to 0.010t, such as greater than or equal to 0.015t, greater than or equal to 0.020t, greater than or equal to 0.025t, greater than or equal to 0.030t, greater than or equal to 0.035t, greater than or equal to 0.040t, greater than or equal to 0.045t, greater than or equal to 0.050t, greater than or equal to 0.055t, greater than or equal to 0.060t, greater than or equal to 0.065t, greater than or equal to 0.070t, greater than or equal to 0.075t, greater than or equal to 0.080t, greater than or equal to 0.085t, greater than or equal to 0.090t, greater than or equal to 0.095t, greater than or equal to 0.10t, greater than or equal to 0.15t, greater than or equal to 0.20t, or more. In some embodiments, the DOL may be from greater than 0.005t to less than or equal to 0.205t, such as from greater than or equal to 0.010t to less than or equal to 0.200t, from greater than or equal to 0.015t to less than or equal to 0.195t, from greater than or equal to 0.020t to less than or equal to 0.190t, from greater than or equal to 0.025t to less than or equal to 0.185t, from greater than or equal to 0.030t to less than or equal to 0.180t, from greater than or equal to 0.035t to less than or equal to 0.175t, from greater than or equal to 0.040t to less than or equal to 0.170t, from greater than or equal to 0.045t to less than or equal to 0.165t, from greater than or equal to 0.050t to less than or equal to 0.160t, from greater than or equal to 0.055t to less than or equal to 0.155t, from greater than or equal to 0.060t to less than or equal to 0.150t, from greater than or equal to 0.065t to less than or equal to 0.145t, from greater than or equal to 0.070t to less than or equal to 0.140t, from greater than or equal to 0.075t to less than or equal to 0.135t, from greater than or equal to 0.080t to less than or equal to 0.130t, from greater than or equal to 0.085t to less than or equal to 0.125t, from greater than or equal to 0.090t to less than or equal to 0.120t, from greater than or equal to 0.095t to less than or equal to 0.115t, from greater than or equal to 0.100t to less than or equal to 0.110t, or any sub-ranges formed by any of these endpoints.

In the embodiments described herein, hydrogen-containing species may be diffused into the glass core layer 102, the clad layers 104a, 104b, or both, after the laminated glass article 100 is formed (such as by the fusion lamination process described herein) and singulated from a larger glass article, such as a ribbon of glass. Similarly, hydrogen-containing species may be diffused into the glass-based article 900 after the glass-based article 900 is formed For example, the hydrogen-containing species may be diffused into the glass core layer 102 by exposing the laminated glass article 100 or glass-based article 900 to an environment comprising water vapor under appropriate conditions (e.g., temperature, pressure, and humidity) to cause hydrogen-containing species from the environment to diffuse into the glass core layer 102.

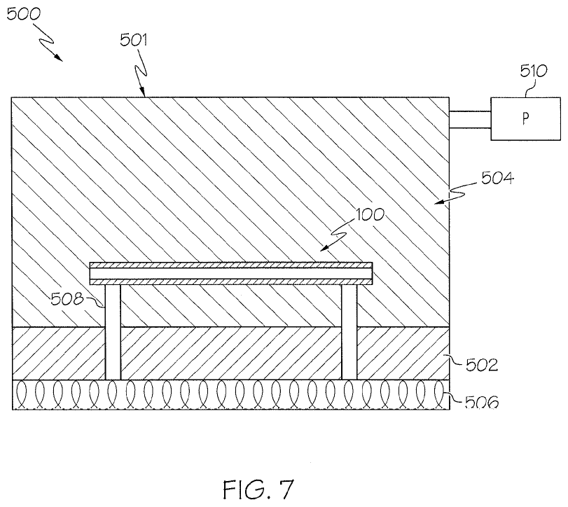

Referring now to FIG. 7, an apparatus 500 for diffusing hydrogen-containing species into a laminated glass article 100 or glass-based article 900 is schematically depicted. The apparatus 500 comprises a pressure vessel 501 coupled to a pressure source 510. The apparatus 500 further comprises a support 508 on which one or more laminated glass articles 100 or glass-based articles 900 may be positioned located within the pressure vessel 501. The apparatus 500 also includes a heat source 506, such as a heating element or the like, for heating liquid water 502 located within the pressure vessel 501 thereby producing an environment containing water vapor 504 at an elevated temperature (i.e., greater than room temperature (20° C.)) within the pressure vessel 501.

In embodiments, the hydrogen-containing species are diffused into the laminated glass article 100 or glass-based article 900 by positioning one or more laminated glass articles 100 or glass-based articles 900 in the pressure vessel 501 on the support 508 such that the laminated glass articles 100 or glass-based articles 900 are elevated above the liquid water 502. The pressure vessel 501 is then pressurized to a pressure greater than or equal to 0.1 MPa (standard atmospheric pressure) and the liquid water 502 is heated with the heat source 506 to create an environment containing water vapor 504 within the pressure vessel 501. Hydrogen-containing species from the environment containing water vapor 504 diffuse into the laminated glass article 100 or glass-based article 900, such as into the glass core layer 102 or glass clad layers 104a, 104b of the laminated glass article, or into any outer edge of the glass-based article 900. The rate of diffusion of the hydrogen-containing species may be varied, for example, by adjusting the temperature, pressure, and/or the concentration of water in the environment containing water vapor 504.

Specifically, various combinations of pressure and temperature may be used with the apparatus 500 to facilitate diffusing hydrogen-containing species into the glass core layer 102 and/or glass clad layers 104a, 104b of the laminated glass article(s) 100 or glass-based articles 900 positioned in the pressure vessel 501. In embodiments, the temperature and/or pressure of the pressure vessel 501 are controlled to produce an environment containing water vapor 504 comprising greater than or equal to 300 grams of water/m³. In embodiments the environment containing water vapor 504 comprises greater than or equal to 400 grams of water/m³ or even greater than or equal to 500 grams of water/m³. In embodiments the environment containing water vapor 504 comprises greater than or equal to 750 grams of water/m³ or even greater than or equal to 1000 grams of water/m³. In embodiments the environment containing water vapor 504 comprises greater than or equal to 5000 grams of water/m³ or even greater than or equal to 10,000 grams of water/m³. In embodiments the environment containing water vapor 504 comprises greater than or equal to 15,000 grams of water/m³ or even greater than or equal to 20,000 grams of water/m³. In embodiments the environment containing water vapor 504 comprises greater than or equal to 30,000 grams of water/m³ or even greater than or equal to 40,000 grams of water/m³. In embodiments the environment containing water vapor 504 comprises greater than or equal to 50,000 grams of water/m³ or even greater than or equal to 100,000 grams of water/m³.

In embodiments, the partial pressure of water in the environment containing water vapor is greater than or equal to 0.075 MPa to facilitate diffusing hydrogen-containing species into the glass core layer 102 and/or the glass clad layers 104a, 104b of the laminated glass article(s) 100, or surface of the glass-based articles 900, positioned in the pressure vessel 501. In embodiments the partial pressure of water in the environment containing water vapor is greater than or equal to 0.1 MPa or even greater than or equal to 0.5 MPa. In embodiments the partial pressure of water in the environment containing water vapor is greater than or equal to 1 MPa or even greater than or equal to 1.5 MPa. In embodiments the partial pressure of water in the environment containing water vapor is greater than or equal to 2 MPa or even greater than or equal to 2.5 MPa. In embodiments the partial pressure of water in the environment containing water vapor is greater than or equal to 3 MPa or even greater than or equal to 3.5 MPa. In embodiments the partial pressure of water in the environment containing water vapor is greater than or equal to 4 MPa or even greater than or equal to 4.5 MPa. In embodiments the partial pressure of water in the environment containing water vapor is greater than or equal to 5 MPa or even greater than or equal to 5.5 MPa. In embodiments the partial pressure of water in the environment containing water vapor is greater than or equal to 6 MPa or even greater than or equal to 6.5 MPa. In embodiments the partial pressure of water in the environment containing water vapor is greater than or equal to 7 MPa or even greater than or equal to 7.5 MPa. In embodiments the partial pressure of water in the environment containing water vapor is greater than or equal to 8 MPa or even greater than or equal to 8.5 MPa. In embodiments the partial pressure of water in the environment containing water vapor is greater than or equal to 9 MPa or even greater than or equal to 9.5 MPa. In embodiments the partial pressure of water in the environment containing water vapor is greater than or equal to 10 MPa or even greater than or equal to 11 MPa. In embodiments the partial pressure of water in the environment containing water vapor is greater than or equal to 12 MPa or even greater than or equal to 13 MPa. In embodiments the partial pressure of water in the environment containing water vapor is greater than or equal to 14 MPa or even greater than or equal to 15 MPa. In embodiments the partial pressure of water in the environment containing water vapor is greater than or equal to 16 MPa or even greater than or equal to 17 MPa. In embodiments the partial pressure of water in the environment containing water vapor is greater than or equal to 18 MPa or even greater than or equal to 19 MPa. In embodiments the partial pressure of water in the environment containing water vapor is greater than or equal to 20 MPa or even greater than or equal to 21 MPa. In embodiments the partial pressure of water in the environment containing water vapor is greater than or equal to 22 MPa.

In embodiments, the partial pressure of water in the environment containing water vapor is greater than or equal to 0.075 MPa and less than or equal to 9 MPa to facilitate diffusing hydrogen-containing species into the glass core layer 102 and/or glass clad layers 104a, 104b of the laminated glass article(s) 100 or glass-based article(s) 900 positioned in the pressure vessel 501. In embodiments, the partial pressure of water in the environment containing water vapor is greater than or equal to 0.1 MPa and less than or equal to 8.5. In embodiments, the partial pressure of water in the environment containing water vapor is greater than or equal to 0.5 MPa and less than or equal to 8.5. In embodiments, the partial pressure of water in the environment containing water vapor is greater than or equal to 1 MPa and less than or equal to 8 MPa. In embodiments, the partial pressure of water in the environment containing water vapor is greater than or equal to 2 MPa and less than or equal to 8 MPa. In embodiments, the partial pressure of water in the environment containing water vapor is greater than or equal to 3 MPa and less than or equal to 7.5. In embodiments, the partial pressure of water in the environment containing water vapor is greater than or equal to 4 MPa and less than or equal to 7. In embodiments, the partial pressure of water in the environment containing water vapor is greater than or equal to 5 MPa and less than or equal to 7.

In embodiments, the environment containing water vapor 504 is heated to a temperature of at least about 70° C. to diffuse the hydrogen-containing species into the glass core layer 102 and/or glass clad layers 104a, 104b of the laminated glass article(s) 100 or glass-based article(s) 900. For example, in embodiments, the environment containing water vapor 504 is heated to a temperature of at least about 75° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., at least about 340° C., or even at least about 350° C. or more. In some embodiments, the laminated glass article 100 or glass-based article 900 may be exposed to an environment containing water vapor at a temperature of about 70° C. to about 350° C., such as about 75° C. to about 345° C., about 80° C. to about 340° C., about 85° C. to about 335° C., about 90° C. to about 330° C., about 95° C. to about 325° C., about 100° C. to about 320° C., about 105° C. to about 315° C., about 110° C. to about 310° C., about 115° C. to about 305° C., about 120° C. to about 300° C., about 125° C. to about 295° C., about 130° C. to about 290° C., about 135° C. to about 285° C., or any sub-ranges formed from these endpoints.

In embodiments, the environment containing water vapor 504 is also pressurized to a treatment pressure that is greater than or equal to 0.1 MPa to diffuse the hydrogen-containing species into the glass core layer 102 and/or glass clad layers 104a, 104b of the laminated glass article(s) 100 or glass-based article(s) 900. Pressurizing the environment containing water vapor 504 increases the concentration of water vapor (i.e., the grams of water/m³) in the pressure vessel 501, thereby increasing the rate of diffusion of hydrogen-containing species into the glass core layer 102 and/or glass clad layers 104a, 104b of the laminated glass article(s) 100 or glass-based article(s) 900. In embodiments, the treatment pressure is greater than or equal to about 0.1 MPa, greater than or equal to 0.2 MPa, greater than or equal to 0.3 MPa, greater than or equal to 0.4 MPa, greater than or equal to 0.5 MPa, greater than or equal to 1.0 MPa, greater than or equal to about 2.0 MPa, greater than or equal to 3.0 MPa, greater than or equal to 4.0 MPa, greater than or equal to 5.0 MPa, greater than or equal to 6.0 MPa, greater than or equal to 7.0 MPa, greater than or equal to 8.0 MPa, greater than or equal to 9.0 MPa, greater than or equal to 10.0 MPa, greater than or equal to 11.0 MPa, greater than or equal to 12.0 MPa, greater than or equal to 13.0 MPa, greater than or equal to 14.0 MPa, greater than or equal to 15.0 MPa, greater than or equal to 16.0 MPa, greater than or equal to 17.0 MPa, greater than or equal to 18.0 MPa, greater than or equal to 19.0 MPa, greater than or equal to 20.0 MPa, greater than or equal to 21.0 MPa, greater than or equal to 22.0 MPa, greater than or equal to 23.0 MPa, greater than or equal to 24.0 MPa, or even greater than or equal to 25.0 MPa. For example, in some embodiments, the treatment pressure is greater than or equal to 0.1 MPa and less than or equal to 25.0 MPa, such as greater than or equal to 1.0 MPa and less than or equal to 25.0 MPa, greater than or equal to 5.0 MPa and less than or equal to 25.0 MPa, or even greater than or equal to 10.0 MPa and less than or equal to 25.0 MPa, or any sub-ranges formed from these endpoints.

In the embodiments described herein, the laminated glass article 100 or glass-based article 900 may be exposed to the environment containing water vapor 504 for at least about 0.04 days or even at least about 0.25 days to facilitate diffusing the hydrogen-containing species into the glass core layer 102 and/or glass clad layers 104a, 104b of the laminated glass article(s) 100 or glass-based article(s) 900. For example, in some embodiments, the laminated glass article 100 may be exposed to the environment containing water vapor 504 for at least about 0.3 days, at least about 0.4 days, at least about 0.5 days, at least about 0.6 days, at least about 0.7 days, at least about 0.8 days, at least about 0.9 days, or even at least about 1 day. In some embodiments, the laminated glass article 100 may be exposed to the environment containing water vapor 504 for at least about 2 days, at least about 3 days, at least about 4 days, at least about 5 days, at least about 6 days, at least about 7 days, at least about 8 days, at least about 9 days, at least about 10 days, at least about 15 days, at least about 20 days, at least about 25 days, at least about 30 days, at least about 35 days, at least about 40 days, at least about 45 days, at least about 50 days, at least about 55 days, at least about 60 days, or even at least about 65 days. In some embodiments, the glass-based substrate may be exposed to the water vapor containing environment for about 0.04 days or even about 0.25 days to about 70 days, such as about 0.5 days to about 65 days, about 1 day to about 60 days, about 2 days to about 55 days, about 3 days to about 45 days, about 4 days to about 40 days, about 5 days to about 35 days, about 6 days to about 30 days, about 7 days to about 25 days, about 8 days to about 20 days, or any sub-ranges formed from any of these endpoints.

It should be understood that the conditions under which the laminated glass article 100 or glass-based article 900 is exposed to the environment containing water vapor 504 may be modified to decrease the time necessary to diffuse the hydrogen-containing species into the glass core layer 102 and/or glass clad layers 104a, 104b of the laminated glass article(s) 100 or glass-based article(s) 900. For example, in embodiments, the temperature and/or treatment pressure may be increased to decrease the time required to achieve the amount of diffusion of hydrogen-containing species into the glass core layer 102 and/or glass clad layers 104a, 104b of the laminated glass article(s) 100 or glass-based article(s) 900. However, it should be understood that combinations of pressure and temperature which result in the water vapor 504 within the pressure vessel 501 condensing to liquid water should be avoided.

Based on the foregoing, description, it should be understood that the inward diffusion of hydrogen-containing species into the glass core layer or glass clad layer of a laminated glass article, or into any surface of a glass-based article may be utilized to produce compressive stresses in the glass. When only the glass core is strengthened by hydrogen diffusion, these compressive stresses offset the tensile stresses in the glass core layer proximate the edges due to lamination, thereby reducing the susceptibility of the laminated glass article to failure from mechanical contact with the exposed edges of the glass core layer. Additionally, hydrogen diffusion may increase compressive stress on at least a major surface of a glass-based article or clad of a laminated article

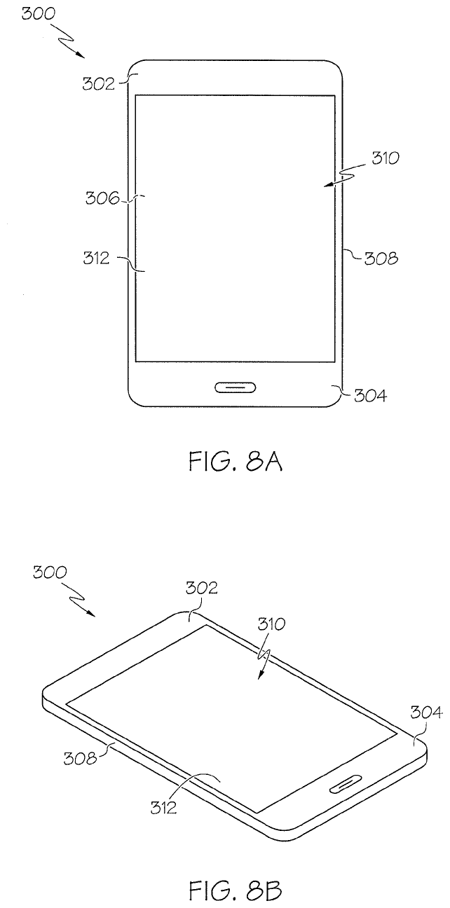

The laminated glass articles or glass-based articles disclosed herein may be incorporated into other articles such as articles with displays (or display articles) (e.g., consumer electronics, including monitors, televisions, mobile phones, tablets, computers, navigation systems, wearable devices (e.g., watches) and the like), architectural articles, transportation articles (e.g., windows for vehicles including cars, trucks, trains, aircraft, sea craft, etc.), appliance articles, or any article that requires some transparency and improved resistance to damage. An exemplary article incorporating any of the laminated glass articles or glass-based articles disclosed herein is schematically depicted in FIGS. 8A and 8B. Specifically, FIGS. 8A and 8B show a consumer electronic device 300 including a housing 302 having front 304, back 306, and side surfaces 308; electrical components (not shown) that are at least partially inside or entirely within the housing and including at least a controller, a memory, and a display 310 at or adjacent to the front surface of the housing; and a cover substrate 312 at or over the front surface of the housing such that it is over the display. In some embodiments, at least a portion of one of the cover substrate 312 and the housing 302 may include any of the laminated glass articles or glass-based articles disclosed herein.

### EXAMPLES

The embodiments described herein will be further clarified by the following examples.

### Example 1

To assess the effect of processing conditions on the compressive stress and depth of layer due to the diffusion of hydrogen-containing species into a glass substrate, 1 mm thick glass samples formed from the glass clad layer compositions listed in Table 1 were exposed to an environment containing water vapor under the conditions set forth below in Tables 3A and 3B below. Following exposure, the samples were analyzed with a surface stress meter (FSM) to determine the compressive stress (MPa) and depth of compression (DOC) of the compressive stress due to exposure to the water containing environment.

TABLE 3A
Glass substrates exposed to water vapor
at elevated temperature and pressure.

| Sample | 1 | 2 | 3 | 4 | 5 |
|---|---|---|---|---|---|
| Glass Composition | C2 | C2 | C2 | C2 | C1 |
| Steam | 100% | 100% | 100% | 100% | 100% |
| Pressure (MPa) | 2.5 | 2.5 | 4.0 | 1.6 | 4.0 |
| Temperature (° C.) | 225 | 225 | 250 | 200 | 250 |
| Water Concentration | 11546 | 11546 | 19965 | 7862 | 19965 |
| (g/m³) | | | | | |
| Time (h) | 6 | 48 | 24 | 48 | 24 |
| FSM Compressive Stress | 435 | 254 | 432 | 413 | 259 |
| (MPa) | | | | | |
| FSM Depth of | 5.6 | 11.5 | 7 | 7.8 | 6 |
| Compression (microns) | | | | | |

TABLE 3B
Glass substrates exposed to water vapor at
elevated temperature and ambient pressure.

| Sample | 6 | 7 |
|---|---|---|
| Glass Composition | C1 | C2 |
| Steam | 100% | 100% |
| Pressure (MPa) | 0.1 | 0.1 |
| Temperature (° C.) | 200 | 200 |
| Water Concentration (g/m³) | 460 | 460 |
| Time (h) | 72 | 72 |
| FSM Compressive Stress (MPa) | 298 | 240 |
| FSM Depth of Compression | 6 | 7 |
| (microns) | | |

Tables 3A and 3B demonstrate that increasing the pressure during exposure to the water vapor significantly reduces the time required to achieve a similar depth of compression (compare, e.g., Table 3A, Sample 4 and Table 3B, Sample 7). The data also indicates that increasing the pressure results in a significant increase in the magnitude of the compressive stress at the surface of the glass in a relatively short period of time, but that longer term exposure at the same pressure reduces the surface compressive stress while increasing the depth of compression (compare, e.g., Table 3A, Sample 1 and Sample 2). However, decreasing the temperature and pressure during the longer term exposure may maintain the surface compressive stress at a relatively high level while also providing a slight increase in the depth of compression (compare, e.g., Table 3A, Sample 1 and Sample 4).

### Example 2

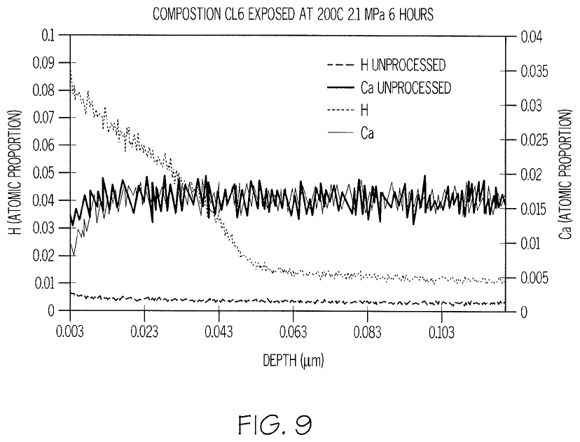

To assess the hydrogen diffusivity of different core glass compositions, samples of 1 mm glass substrates were formed from compositions C1 and C2 of Table 1 (i.e., glass core layer compositions) and compositions CL1 of Table 2A and composition CL5 of Table 2B (i.e., glass clad layer compositions). The samples were analyzed by secondary ion mass spectrometry (SIMS) before and after exposure to an environment containing water vapor (7862 g/m³ H₂O) for a treatment time 6 hours at a temperature of 200° C. and a treatment pressure of 1.6 MPa to determine the depth of diffusion of hydrogen-containing species and the effect of the exposure on the concentration of other species in the glass network. The results of the SIMS analysis are presented in FIGS. 9-12.

Referring to FIG. 9, FIG. 9 graphically depicts the concentration of hydrogen (left Y ordinate) and the concentration of calcium (right Y ordinate) as function of depth (X ordinate) for glass clad layer composition CL5 both before and after exposure to the environment containing water vapor. As shown in FIG. 9, the concentration of calcium as a function of depth was approximately the same both before and after exposure to the environment containing water vapor, indicating that exposure does not affect the other constituent components of the glass composition. FIG. 9 also shows that, prior to exposure to the environment containing water vapor, the concentration of hydrogen was low and fairly uniform as function of depth. However, after exposure, the glass contained additional hydrogen which penetrated to a shallow depth of approximately 50 nm. FIG. 9 shows that, after exposure, the concentration of hydrogen in the glass rapidly decreases from the surface of the glass, indicating that hydrogen-containing species have relatively poor diffusivity in the glass.

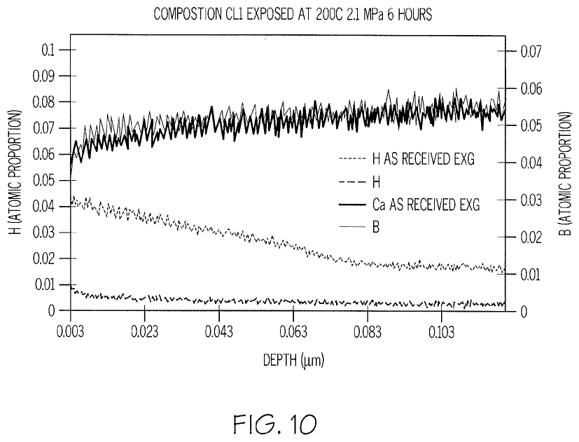

Referring now to FIG. 10, FIG. 10 graphically depicts the concentration of hydrogen (left Y ordinate) and the concentration of boron (right Y ordinate) as function of depth (X ordinate) for glass clad layer composition CL1 both before and after exposure to the environment containing water vapor. As shown in FIG. 10, the concentration of boron as a function of depth was approximately the same both before and after exposure to the environment containing water vapor, indicating that exposure does not affect the other constituent components of the glass composition. FIG. 10 also shows that, prior to exposure to the environment containing water vapor, the concentration of hydrogen was low and fairly uniform as a function of depth. However, after exposure, the glass contained additional hydrogen which penetrated to a shallow depth of approximately 80 nm. FIG. 10 shows that the concentration of hydrogen rapidly decreased from the surface of the glass, indicating that hydrogen-containing species have relatively poor diffusivity in the glass.

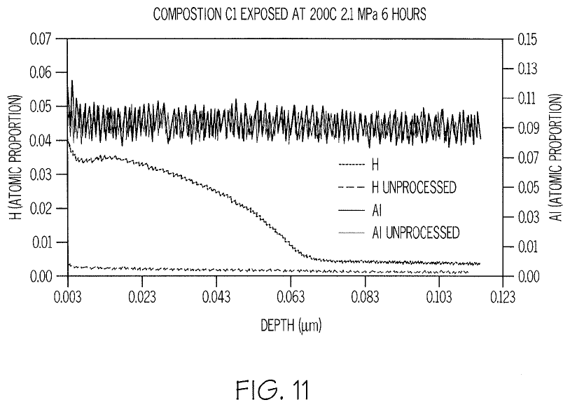

Referring now to FIG. 11, FIG. 11 graphically depicts the concentration of hydrogen (left Y ordinate) and the concentration of aluminum (right Y ordinate) as function of depth (X ordinate) for glass core layer composition C1 both before and after exposure to the environment containing water vapor. As shown in FIG. 11, the concentration of aluminum as a function of depth was approximately the same both before and after exposure to the environment containing water vapor, indicating that exposure does not affect the other constituent components of the glass composition. FIG. 11 also shows that, prior to exposure to the environment containing water vapor, the concentration of hydrogen was low and fairly uniform as a function of depth. However, after exposure, the glass contained additional hydrogen which penetrated to a depth of approximately 750 nm. Thus, FIG. 11 indicates that hydrogen-containing species have relatively good diffusivity in the glass, particularly in comparison to glass clad layer composition CL5 (FIG. 9) and glass clad layer composition CL1 (FIG. 10).

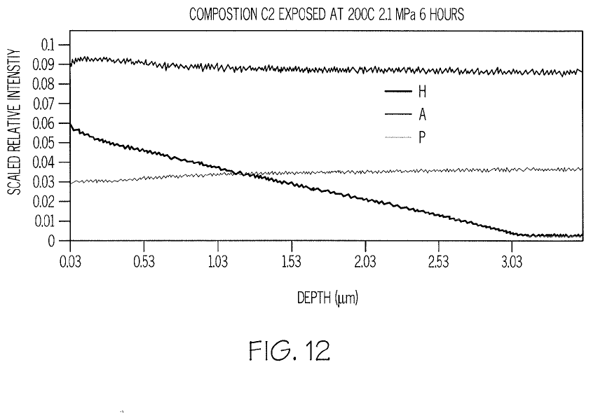

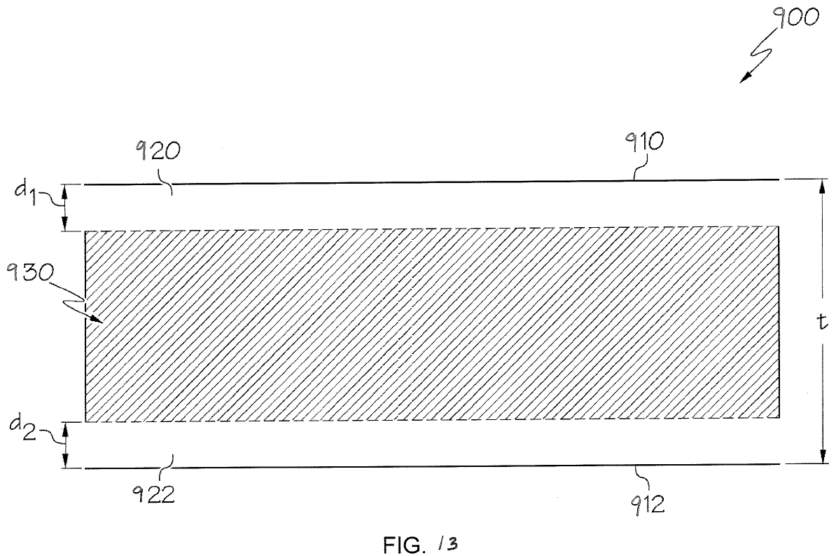

Referring now to FIG. 12, FIG. 12 graphically depicts the scaled relative intensity of hydrogen, phosphorous, and aluminum (left Y ordinate) as function of depth (X ordinate) for glass core layer composition C2 after exposure to the environment containing water vapor. FIG. 12 shows that the concentration of aluminum was substantially uniform as a function of depth after exposure to the environment containing water vapor. FIG. 12 also shows that, after exposure to the environment containing water vapor, the concentration of phosphorous proximate the surface of the glass decreased, potentially indicating that, in addition to the diffusion of hydrogen-containing species into the surface of the glass, phosphorous ions may be exchanged out of the glass during the exposure. This data supports the hypothesis that additions of phosphorous in the glass, such as P₂O₅, improve the susceptibility of the glass to the inward diffusion of hydrogen-containing species. FIG. 12 also shows that, after exposure, the glass contained additional hydrogen which penetrated to a depth of approximately 3 μm. Thus, FIG. 12 indicates that hydrogen-containing species have relatively good diffusivity in the glass, particularly in comparison to glass clad layer composition CL5 (FIG. 9) and glass clad layer composition CL1 (FIG. 10).

### Example 3

Laminated glass articles comprising a glass core layer fused to glass cladding layers (as depicted in FIG. 1) were modelled based on the glass core layer compositions C1 and C2 in Table 1 and the glass clad layer compositions CL1-CL8 in Tables 2A and 2B. The laminated glass articles were modelled with a glass core layer having a thickness of 750 μm and glass clad layer having thicknesses of 15 μm (total laminate thickness=780 μm). The stress in the glass clad layers was calculated using the equations described herein. The data for various glass core layer and glass clad layer combinations is reported in Tables 4A-4B below showing that the identified core/clad pairs result in a compressive stress in the glass clad layers.

TABLE 4A
Modelled laminated glass articles.

| | Core/Clad Pair | | Core/Clad Pair | | Core/Clad Pair | | Core/Clad Pair | |
|---|---|---|---|---|---|---|---|---|
| Core/Clad | Core | Clad | Core | Clad | Core | Clad | Core | Clad |
| Composition | C1 | CL1 | C2 | CL1 | C1 | CL2 | C2 | CL2 |
| RUS E (GPa) | 65.8 | 73.8 | 63.9 | 73.8 | 65.8 | 79.6 | 63.9 | 79.6 |
| RUS Poisson's | 0.219 | 0.223 | 0.205 | 0.223 | 0.219 | 0.229 | 0.205 | 0.229 |
| Ratio | | | | | | | | |
| BBV Strain | 591 | 682.8 | 556 | 682.8 | 591 | 721.1 | 556 | 721.1 |
| Pt. (° C.) | | | | | | | | |
| Core | 750 | | 750 | | 750 | | 750 | |
| Thickness | | | | | | | | |
| Clad | 25 | | 25 | | 25 | | 25 | |
| Thickness | | | | | | | | |
| k | 15 | | 15 | | 15 | | 15 | |
| E_{eff} core | 96 | | 90 | | 96 | | 90 | |
| E_{eff} clad | 109 | | 109 | | 119 | | 119 | |
| CTE (×10⁻⁷/° C) | 84.9 | 37.1 | 84.9 | 37.1 | 84.9 | 33.9 | 97.3 | 33.9 |
| Effective | 658 | | 658 | | 696 | | 696 | |
| temperature | | | | | | | | |
| Clad Stress | 235 | | 234 | | 271 | | 270 | |
| (Mpa) | | | | | | | | |

TABLE 4B
Modelled laminated glass articles.

| | Core/Clad Pair | | Core/Clad Pair | | Core/Clad Pair | | Core/Clad Pair | |
|---|---|---|---|---|---|---|---|---|
| Core/Clad | Core | Clad | Core | Clad | Core | Clad | Core | Clad |
| Composition | C1 | CL3 | C2 | CL3 | C1 | CL4 | C2 | CL4 |
| RUS E (GPa) | 65.8 | 80.8 | 63.9 | 80.8 | 65.8 | 81.1 | 63.9 | 81.1 |
| RUS Poisson′s | 0.219 | 0.229 | 0.205 | 0.229 | 0.219 | 0.231 | 0.205 | 0.231 |
| Ratio | | | | | | | | |
| BBV Strain | 591 | 728.1 | 556 | 728.1 | 591 | 749.6 | 556 | 749.6 |
| Pt. (° C.) | | | | | | | | |
| Core | 750 | | 750 | | 750 | | 750 | |
| Thickness | | | | | | | | |
| Clad | 25 | | 25 | | 25 | | 25 | |
| Thickness | | | | | | | | |
| k | 15 | | 15 | | 15 | | 15 | |
| E_{eff} core | 96 | | 90 | | 96 | | 90 | |
| E_{eff} clad | 121 | | 121 | | 122 | | 122 | |
| CTE | 84.9 | 37.2 | 97.3 | 36.2 | 84.9 | 34.5 | 97.3 | 34.5 |
| (x10⁻⁷/° C.) | | | | | | | | |
| Effective | 703 | | 703 | | 725 | | 725 | |
| temperature | | | | | | | | |
| Clad Stress | 278 | | 276 | | 289 | | 287 | |
| (MPa) | | | | | | | | |

TABLE 4C
Modelled laminated glass articles.

| | Core/Clad Pair | | Core/Clad Pair | | Core/Clad Pair | | Core/Clad Pair | |
|---|---|---|---|---|---|---|---|---|
| Core/Clad | Core | Clad | Core | Clad | Core | Clad | Core | Clad |
| Composition | C1 | CL5 | C2 | CL5 | C1 | CL6 | C2 | CL6 |
| RUS E (GPa) | 65.8 | 82.6 | 63.9 | 82.6 | 65.8 | 84.1 | 63.9 | 84.1 |
| RUS Poisson′s | | | | | | | | |
| Ratio | 0.219 | 0.231 | 0.205 | 0.231 | 0.219 | 0.227 | 0.205 | 0.227 |
| BBV Strain | | | | | | | | |
| Pt. (° C.) | 591 | 749.3 | 556 | 749.3 | 591 | 760.8 | 556 | 760.8 |
| Core | | | | | | | | |
| Thickness | 750 | | 750 | | 750 | | 750 | |
| Clad | | | | | | | | |
| Thickness | 25 | | 25 | | 25 | | 25 | |
| k | 15 | | 15 | | 15 | | 15 | |
| E_{eff} core | 96 | | 90 | | 96 | | 90 | |
| E_{eff} clad | 125 | | 125 | | 126 | | 126 | |
| CTE | 84.9 | 35.3 | 97.3 | 35.3 | 84.9 | 34.9 | 97.3 | 34.9 |
| (x10⁻⁷/° C.) | | | | | | | | |
| Effective | 724 | | 724 | | 736 | | 736 | |
| temperature | | | | | | | | |
| Clad Stress | 293 | | 292 | | 300 | | 298 | |
| (MPa) | | | | | | | | |

### Example 4

Glass compositions that are particularly suited for formation of some embodiments the glass-based articles described herein were formed into glass-based substrates, and the glass compositions are provided in Tables 5A-5E, below. The density of the glass compositions was determined using the buoyancy method of ASTM C693-93(2013). The linear coefficient of thermal expansion (CTE) over the temperature range 25° C. to 300° C. is expressed in terms of 10⁻⁷/° C. and was determined using a push-rod dilatometer in accordance with ASTM E228-11. The strain point and anneal point were determined using the beam bending viscosity method of ASTM C598-93(2013). The softening point was determined using the parallel plate viscosity method of ASTM C1351M-96(2012). SOC was measured according to Procedure C (Glass Disc Method) described in ASTM standard C770-16, entitled “Standard Test Method for Measurement of Glass Stress-Optical Coefficient.” Where the SOC and refractive index (RI) are not reported in Tables 5A-5E, default values of these properties were utilized for those compositions, with a SOC of 3.0 nm/mm/MPa and a RI of 1.5. The Young's modulus, shear modulus, and Poisson's ratio of the glass is determined by resonant ultrasound spectroscopy on bulk samples of each glass composition.

TABLE 5A
Glass compositions

| Glass Composition | D1 | D2 | D3 | D4 | D5 | D6 |
|---|---|---|---|---|---|---|
| SiO₂ | 65.28 | 65.34 | 65.33 | 65.36 | 65.53 | 65.37 |
| Al₂O₃ | 13.99 | 13.97 | 13.97 | 11.99 | 12.00 | 11.99 |
| P₂O₅ | 4.90 | 4.94 | 4.91 | 4.85 | 4.81 | 4.89 |
| B₂O₃ | | | | | | |
| Li₂O | | | | | | |
| Na₂O | 15.82 | 13.76 | 11.79 | 17.76 | 15.63 | 13.71 |
| K₂O | | | | | | |
| Rb₂O | | | | | | |
| MgO | 0.02 | 1.99 | 3.99 | 0.00 | 1.98 | 3.99 |
| CaO | | | | 0.02 | 0.03 | 0.04 |
| BaO | | | | | | |
| ZnO | | | | | | |
| ZrO2 | | | | | | |
| SnO₂ | | | | | | |
| Density (g/cm³) | 2.392 | 2.388 | 2.388 | 2.401 | 2.4 | 2.398 |
| CTE *10⁻⁷ (1/° C.) | 83.10 | 77.40 | 70.20 | | | |
| Strain Pt. (° C.) | 622.7 | 654.1 | 678.9 | | | |
| Anneal Pt. (° C.) | 680.6 | 713.1 | 738.8 | | | |
| Softening Pt. (° C.) | 964.6 | 985.3 | 1010.8 | | | |
| Stress optical coefficient | 3.126 | 3.173 | 3.16 | | | |
| (nm/mm/MPa) | | | | | | |
| Refractive index at 589.3 nm | 1.4879 | 1.4885 | 1.4891 | | | |
| Young′s modulus (GPa) | 63.85 | 65.64 | 68.05 | 63.36 | 64.95 | 66.12 |
| Shear modulus (GPa) | 21.53 | 27.51 | 28.41 | 26.27 | 26.96 | 27.65 |
| Poisson′s ratio | 0.2 | 0.192 | 0.196 | 0.207 | 0.204 | 0.195 |

TABLE 5B
Glass compositions

| Glass Composition | D7 | D8 | D9 | D10 | D11 | D12 |
|---|---|---|---|---|---|---|
| SiO₂ | 65.42 | 65.32 | 63.3 | 63.92 | 63.16 | 61.96 |
| Al₂O₃ | 11.97 | 11.96 | 15.75 | 10.06 | 11.15 | 12.06 |
| P₂O₅ | 4.88 | 4.91 | 2.5 | 6.82 | 6.64 | 6.80 |
| B₂O₃ | | | | | | |
| Li₂O | | | | | | |
| Na₂O | 11.67 | 9.77 | 17.2 | 4.91 | 4.86 | 4.91 |
| K₂O | | | | 9.18 | 9.15 | 9.16 |
| Rb₂O | | | | | | |
| MgO | 5.99 | 7.96 | | 0.02 | 0.02 | 0.02 |
| CaO | 0.06 | 0.07 | | 0.02 | 0.02 | 0.02 |
| BaO | | | | | | |
| ZnO | | | 1.2 | 4.98 | 4.90 | 4.97 |
| ZrO2 | | | | | | |
| SnO₂ | | | 0.05 | 0.06 | 0.06 | 0.06 |
| Density (g/cm³) | 2.399 | 2.402 | 2.444 | 2.449 | 2.454 | 2.454 |
| CTE *10-7 (1/° C.) | | | 86.2 | 92.3 | 91 | 88.7 |
| Strain Pt. (° C.) | | | 646.6 | 650 | 646 | 644 |
| Anneal Pt. (° C.) | | | 703.7 | 727 | 724 | 719 |
| Softening Pt. (° C.) | | | 996.2 | 1010.6 | 996.7 | 984 |
| Stress optical coefficient | | | 3.242 | 3.224 | 3.244 | |
| (nm/mm/MPa) | | | | | | |
| Refractive index at 589.3 nm | | | | 1.4907 | 1.4921 | 1.4928 |
| Young′s modulus (GPa) | 67.91 | 70.12 | 67.91 | | | |
| Shear modulus (GPa) | 28.41 | 29.37 | 28.13 | | | |
| Poisson′s ratio | 0.195 | 0.195 | 0.208 | | | |

TABLE 5C
Glass compositions

| Glass Composition | D13 | D14 | D15 | D16 | D17 | D18 |
|---|---|---|---|---|---|---|
| SiO₂ | 66.76 | 66.08 | 64.84 | 58.8 | 48.50 | 62.06 |
| Al₂O₃ | 10.11 | 11.14 | 12.11 | 4.0 | 19.98 | 13.47 |
| P₂O₅ | 3.88 | 3.73 | 3.89 | 3.2 | 3.37 | 4.79 |
| B₂O₃ | | | | | | 0.00 |
| Li₂O | | | | | | |
| Na₂O | 4.90 | 4.86 | 4.90 | 12.1 | 7.34 | 19.55 |
| K₂O | 9.27 | 9.21 | 9.20 | 12.1 | 20.71 | 0.01 |
| Rb₂O | | | | | | |
| MgO | 0.02 | 0.02 | 0.03 | | | 0.01 |
| CaO | 0.02 | 0.02 | 0.02 | | | 0.02 |
| BaO | | | | 1.6 | | |
| ZnO | 4.95 | 4.86 | 4.92 | 6.4 | | 0.00 |
| ZrO2 | | | | 1.6 | | |
| SnO₂ | 0.05 | 0.05 | 0.06 | 0.1 | 0.1 | 0.05 |
| Density (g/cm³) | 2.468 | 2.472 | 2.475 | | 2.483 | 2.426 |
| CTE *10⁻⁷ (1/° C.) | 90.8 | 91.1 | 89.6 | | | 94.1 |
| Strain Pt. (° C.) | 635 | 658 | 684 | | | 574 |
| Anneal Pt. (° C.) | 708 | 733 | 758 | | | 625 |
| Softening Pt. (° C.) | 100.8 | 1008.2 | 1001.8 | | | 872 |
| Stress optical coefficient | 3.304 | 3.31 | | | 2.688 | 2.96 |
| (nm/mm/MPa) | | | | | | |
| Refractive index at 589.3 nm | 1.4956 | 1.4972 | 1.498 | | 1.5061 | 1.492 |
| Young′s modulus (GPa) | | | | | 64.88 | |
| Shear modulus (GPa) | | | | | 26.54 | |
| Poisson′s ratio | | | | | 0.221 | |

TABLE 5D
Glass compositions

| Glass Composition | D19 | D20 | D21 | D22 | D23 | D24 |
|---|---|---|---|---|---|---|
| SiO₂ | 57.53 | 53.81 | 57.11 | 60.69 | 66.23 | 78.50 |
| Al₂O₃ | 13.58 | 14.54 | 12.74 | 14.01 | 16.39 | 2.07 |
| P₂O₅ | 9.53 | 6.78 | 6.55 | 7.73 | 1.97 | |
| B₂O₃ | 0.00 | 2.86 | 2.53 | 0.00 | | |
| Li₂O | | | | | | |
| Na₂O | 19.23 | 17.86 | 18.96 | 13.63 | 1.70 | 5.15 |
| K₂O | 0.01 | 0.01 | 0.01 | 3.80 | 7.08 | 5.62 |
| Rb₂O | | | | | | |
| MgO | 0.02 | 0.02 | 0.02 | 0.03 | 0.42 | 7.95 |
| CaO | 0.02 | 0.02 | 0.02 | 0.02 | 6.12 | 0.03 |
| BaO | | | | | | |
| ZnO | 0.00 | 4.06 | 2.04 | 0.00 | | 0.57 |
| ZrO2 | | | | | | |
| SnO₂ | 0.05 | 0.00 | 0.00 | 0.05 | 0.10 | 0.10 |
| Density (g/cm³) | 2.408 | 2.477 | 2.446 | 2.399 | 2.437 | 2.384 |
| CTE *10⁻⁷ (1/° C.) | 97.1 | 90.4 | 94.7 | 94.3 | 60.6 | 73.1 |
| Strain Pt. (° C.) | 522 | 531.9 | 521.1 | 552.1 | 724.7 | 534.7 |
| Anneal Pt. (° C.) | 568 | 582.4 | 570.7 | 610.9 | 772.6 | 588.9 |
| Softening Pt. (° C.) | 825.1 | 826 | 785 | 897.2 | | 859.9 |
| Stress optical coefficient | 2.974 | 3.249 | 3.077 | 3.006 | 2.646 | |
| (nm/mm/MPa) | | | | | | |
| Refractive index at 589.3 nm | 1.4858 | 1.4989 | 1.49445 | 1.4865 | 1.5304 | |
| Young′s modulus (GPa) | | | | | 73.22 | 67.62 |
| Shear modulus (GPa) | | | | | 30.13 | 28.32 |
| Poisson′s ratio | | | | | 0.215 | 0.1943 |

TABLE 5E
Glass compositions

| Glass Composition | D25 | D26 | D27 | D28 | D29 | D30 |
|---|---|---|---|---|---|---|
| SiO₂ | 65.00 | 68.21 | 68.03 | 51.57 | 69.34 | 69.34 |
| Al₂O₃ | 17.34 | 19.50 | 16.38 | 23.72 | 10.30 | 10.27 |
| P₂O₅ | | | | | | |
| B₂O₃ | | | | | | |
| Li₂O | | | | | | |
| Na₂O | 0.64 | 4.55 | 1.74 | 4.18 | 4.31 | 0.97 |
| K₂O | 5.74 | 4.42 | 7.18 | 8.31 | 10.43 | 13.84 |
| Rb₂O | | | | | | |
| MgO | 0.24 | 0.09 | 0.42 | 0.27 | 5.39 | 5.33 |
| CaO | 10.94 | 3.12 | 6.15 | 11.84 | 0.05 | 0.05 |
| BaO | | | | | | |
| ZnO | | | | | | |
| ZrO2 | | | | | | |
| SnO₂ | 0.11 | 0.11 | 0.11 | 0.11 | 0.16 | 0.17 |
| Density (g/cm³) | 2.495 | 2.447 | 2.45 | 2.557 | 2.427 | 2.418 |
| CTE *10⁻⁷ (1/° C.) | 55.3 | 51.4 | 60.9 | 74.3 | 89.8 | 88.2 |
| Strain Pt. (° C.) | 767.1 | 748.6 | 757.7 | 733.4 | 639 | 707 |
| Anneal Pt. (° C.) | 818 | 804.8 | 813.9 | 780.1 | 702 | 775 |
| Softening Pt. (° C.) | 1051 | 1072.2 | 1082 | 990.3 | 987.4 | |
| Stress optical coefficient | 2.847 | 2.98 | 2.942 | 2.645 | 2.925 | 2.931 |
| (nm/mm/MPa) | | | | | | |
| Refractive index at 589.3 nm | 1.5222 | 1.5086 | 1.5096 | 1.5342 | 1.4991 | 1.4978 |
| Young′s modulus (GPa) | 78.94 | 79.36 | 75.64 | 81.50 | 69.09 | 64.84 |
| Shear modulus (GPa) | 32.20 | 32.54 | 31.10 | 32.96 | 28.55 | 26.61 |
| Poisson′s ratio | 0.226 | 0.219 | 0.217 | 0.236 | 0.21 | 0.218 |

### Example 5

Samples having the compositions shown in Tables 5A-5E were exposed to water vapor containing environments to form glass articles having compressive stress layers. The sample composition and thickness as well as the environment the samples were exposed to, including the temperature, pressure, and exposure time are shown in Table 6, below. Each of the treatment environments were saturated with water vapor. The resulting maximum compressive stress and depth of compression as measured by surface stress meter (FSM) is also reported in Table 6.

TABLE 6
Glass substrates exposed to water vapor at elevated temperature

| | | Pressure | | Compressive | Depth of |
|---|---|---|---|---|---|
| Glass | Temperature | of vapor | Time | Stress | Layer |
| Composition | (° C.) | (MPa) | (hours) | (MPa) | (microns) |
| D1 | 175 | 0.76 | 240 | 448 | 11 |
| D1 | 175 | 1 | 72 | 403 | 8 |
| D1 | 200 | 1.46 | 18 | 418 | 6 |
| D1 | 200 | 1.6 | 16 | 379 | 7 |
| D1 | 200 | 1.6 | 32 | 411 | 9 |
| D1 | 225 | 2.6 | 16 | 394 | 10 |
| D1 | 225 | 2.6 | 32 | 354 | 14 |
| D1 | 250 | 4 | 15 | 231 | 11 |
| D1 | 300 | 2.6 | 24 | 192 | 28 |
| D1 | 300 | 2.6 | 96 | 95 | 51 |
| D2 | 175 | 0.76 | 240 | 446 | 10 |
| D2 | 175 | 1 | 72 | 399 | 7 |
| D2 | 200 | 1.46 | 18 | 471 | 5 |
| D2 | 200 | 1.6 | 16 | 327 | 6 |
| D2 | 200 | 1.6 | 32 | 439 | 9 |
| D2 | 225 | 2.6 | 4 | 383 | 5 |
| D2 | 225 | 2.6 | 16 | 420 | 8 |
| D2 | 225 | 2.6 | 32 | 401 | 11 |
| D2 | 250 | 4 | 1 | 426 | 5 |
| D2 | 250 | 4 | 16 | 439 | 14 |
| D2 | 275 | 6 | 4 | 380 | 11 |
| D2 | 275 | 6 | 6 | 357 | 12 |
| D2 | 275 | 6 | 9 | 354 | 15 |
| D2 | 300 | 2.6 | 24 | 258 | 22 |
| D2 | 300 | 2.6 | 96 | 178 | 44 |
| D3 | 225 | 2.6 | 32 | 440 | 8 |
| D3 | 250 | 4 | 16 | 389 | 11 |
| D3 | 275 | 6 | 4 | 434 | 9 |
| D3 | 275 | 6 | 6 | 403 | 9 |
| D3 | 275 | 6 | 9 | 352 | 12 |
| D3 | 275 | 6 | 16 | 351 | 14 |
| D4 | 175 | 0.67 | 240 | 427 | 10 |
| D4 | 200 | 1.6 | 16 | 376 | 7 |
| D4 | 200 | 1.6 | 32 | 390 | 8 |
| D4 | 225 | 2.6 | 16 | 373 | 10 |
| D4 | 250 | 4 | 1 | 301 | 5 |
| D4 | 300 | 2.6 | 24 | 188 | 31 |
| D4 | 300 | 2.6 | 96 | 52 | 47 |
| D5 | 175 | 0.76 | 240 | 452 | 9 |
| D5 | 175 | 1 | 72 | 367 | 7 |
| D5 | 200 | 1.6 | 32 | 390 | 7 |
| D5 | 225 | 2.6 | 16 | 406 | 8 |
| D5 | 225 | 2.6 | 32 | 363 | 12 |
| D5 | 275 | 6 | 4 | 220 | 9 |
| D5 | 300 | 2.6 | 24 | 169 | 23 |
| D6 | 175 | 0.76 | 240 | 452 | 9 |
| D6 | 175 | 1 | 72 | 410 | 6 |
| D6 | 200 | 1.6 | 32 | 385 | 7 |
| D6 | 225 | 2.6 | 16 | 415 | 8 |
| D6 | 225 | 2.6 | 32 | 382 | 11 |
| D6 | 250 | 4 | 16 | 369 | 12 |
| D6 | 275 | 6 | 4 | 388 | 10 |
| D6 | 275 | 6 | 9 | 344 | 14 |
| D7 | 175 | 0.76 | 240 | 427 | 8 |
| D7 | 175 | 1 | 72 | 436 | 6 |
| D7 | 200 | 1.6 | 32 | 397 | 7 |
| D7 | 225 | 2.6 | 16 | 395 | 12 |
| D7 | 275 | 6 | 4 | 417 | 9 |
| D7 | 275 | 6 | 9 | 346 | 14 |
| D8 | 225 | 2.6 | 32 | 495 | 8 |
| D8 | 250 | 4 | 16 | 405 | 9 |
| D8 | 275 | 6 | 4 | 408 | 10 |
| D8 | 275 | 6 | 9 | 397 | 10 |
| D9 | 175 | 0.76 | 240 | 469 | 5 |
| D9 | 225 | 2.6 | 16 | 442 | 6 |
| D9 | 250 | 4 | 4 | 459 | 5 |
| D9 | 275 | 6 | 4 | 395 | 7 |
| D9 | 275 | 6 | 9 | 391 | 10 |
| D10 | 175 | 0.76 | 16 | 352 | 11 |
| D10 | 175 | 0.76 | 32 | 349 | 14 |
| D10 | 175 | 0.76 | 240 | 327 | 34 |
| D10 | 175 | 1 | 16 | 331 | 13 |
| D10 | 200 | 1.6 | 4 | 348 | 12 |
| D10 | 200 | 1.6 | 9 | 313 | 16 |
| D10 | 200 | 1.6 | 16 | 312 | 20 |
| D10 | 250 | 4 | 1 | 248 | 14 |
| D10 | 300 | 2.6 | 24 | 156 | 62 |
| D11 | 175 | 0.76 | 16 | 354 | 10 |
| D11 | 175 | 0.76 | 32 | 359 | 13 |
| D11 | 175 | 0.76 | 240 | 291 | 33 |
| D11 | 175 | 1 | 16 | 350 | 12 |
| D11 | 200 | 1.6 | 9 | 332 | 15 |
| D11 | 200 | 1.6 | 16 | 324 | 18 |
| D11 | 250 | 4 | 1 | 245 | 13 |
| D11 | 300 | 2.6 | 24 | 180 | 63 |
| D12 | 175 | 0.76 | 16 | 361 | 9 |
| D12 | 175 | 0.76 | 32 | 371 | 12 |
| D12 | 175 | 0.76 | 240 | 352 | 27 |
| D12 | 175 | 1 | 16 | 328 | 11 |
| D12 | 200 | 1.6 | 4 | 363 | 10 |
| D12 | 200 | 1.6 | 9 | 346 | 13 |
| D12 | 200 | 1.6 | 16 | 338 | 16 |
| D12 | 250 | 4 | 1 | 270 | 12 |
| D12 | 300 | 2.6 | 24 | 194 | 58 |
| D13 | 175 | 0.76 | 16 | 376 | 7 |
| D13 | 175 | 0.76 | 32 | 365 | 9 |
| D13 | 175 | 0.76 | 72 | 369 | 13 |
| D13 | 175 | 0.76 | 240 | 357 | 22 |
| D13 | 175 | 1 | 16 | 350 | 8 |
| D13 | 200 | 1.6 | 4 | 348 | 8 |
| D13 | 200 | 1.6 | 9 | 349 | 10 |
| D13 | 200 | 1.6 | 16 | 343 | 12 |
| D13 | 225 | 2.6 | 9 | 344 | 15 |
| D13 | 225 | 2.6 | 16 | 307 | 19 |
| D13 | 250 | 4 | 1 | 267 | 9 |
| D13 | 300 | 2.6 | 24 | 159 | 49 |
| D14 | 150 | 0.4 | 64 | 399 | 7 |
| D14 | 175 | 0.76 | 72 | 381 | 12 |
| D14 | 175 | 1 | 16 | 345 | 8 |
| D14 | 200 | 1.6 | 16 | 360 | 12 |
| D14 | 225 | 2.6 | 16 | 335 | 18 |
| D14 | 250 | 4 | 4 | 322 | 16 |
| D14 | 250 | 4 | 9 | 305 | 22 |
| D14 | 250 | 4 | 16 | 270 | 29 |
| D15 | 175 | 0.76 | 16 | 361 | 7 |
| D15 | 175 | 0.76 | 32 | 395 | 9 |
| D15 | 175 | 0.76 | 72 | 429 | 12 |
| D15 | 175 | 0.76 | 240 | 380 | 20 |
| D15 | 175 | 1 | 16 | 362 | 8 |
| D15 | 200 | 1.6 | 4 | 343 | 8 |
| D15 | 200 | 1.6 | 9 | 356 | 10 |
| D15 | 200 | 1.6 | 16 | 358 | 12 |
| D15 | 225 | 2.6 | 9 | 366 | 14 |
| D15 | 225 | 2.6 | 16 | 356 | 18 |
| D15 | 250 | 4 | 4 | 345 | 16 |
| D15 | 275 | 6 | 9 | 285 | 33 |
| D15 | 275 | 6 | 16 | 275 | 39 |
| D15 | 300 | 2.6 | 24 | 244 | 43 |
| D16 | 250 | 1.1 | 6 | 101 | 8 |
| D17 | 150 | 0.4 | 169 | 584 | 5 |
| D17 | 175 | 1 | 16 | 504 | 5 |
| D17 | 175 | 1 | 32 | 444 | 6 |
| D17 | 175 | 1 | 72 | 292 | 7 |
| D17 | 200 | 1.6 | 4 | 503 | 5 |
| D18 | 175 | 0.76 | 16 | 394 | 5 |
| D18 | 175 | 0.76 | 32 | 449 | 6 |
| D18 | 175 | 0.76 | 72 | 426 | 10 |
| D18 | 175 | 0.76 | 240 | 395 | 17 |
| D18 | 175 | 1 | 16 | 419 | 7 |
| D18 | 175 | 1 | 32 | 430 | 8 |
| D18 | 175 | 1 | 72 | 372 | 13 |
| D18 | 200 | 1.6 | 4 | 420 | 7 |
| D18 | 200 | 1.6 | 9 | 375 | 9 |
| D18 | 200 | 1.6 | 16 | 388 | 11 |
| D18 | 225 | 2.6 | 4 | 377 | 11 |
| D18 | 225 | 2.6 | 9 | 363 | 14 |
| D19 | 175 | 0.76 | 16 | 405 | 5 |
| D19 | 175 | 0.76 | 32 | 431 | 7 |
| D19 | 175 | 1 | 16 | 340 | 7 |
| D19 | 175 | 1 | 72 | 346 | 12 |
| D19 | 200 | 1.6 | 4 | 367 | 7 |
| D20 | 225 | 2.6 | 16 | 380 | 7 |
| D20 | 225 | 2.6 | 32 | 363 | 9 |
| D20 | 300 | 2.6 | 24 | 126 | 22 |
| D21 | 175 | 0.76 | 240 | 409 | 8 |
| D21 | 200 | 1.6 | 16 | 318 | 5 |
| D21 | 200 | 1.6 | 32 | 368 | 7 |
| D21 | 225 | 2.6 | 4 | 381 | 5 |
| D21 | 225 | 2.6 | 9 | 373 | 6 |
| D21 | 225 | 2.6 | 16 | 354 | 6 |
| D21 | 300 | 2.6 | 24 | 108 | 27 |
| D21 | 300 | 2.6 | 96 | 105 | 55 |
| D22 | 175 | 0.76 | 240 | 426 | 10 |
| D22 | 225 | 2.6 | 4 | 422 | 6 |
| D22 | 200 | 1.6 | 16 | 377 | 5 |
| D22 | 200 | 1.6 | 32 | 400 | 7 |
| D22 | 225 | 2.6 | 4 | 422 | 6 |
| D22 | 225 | 2.6 | 9 | 417 | 6 |
| D23 | 250 | 4 | 16 | 482 | 5 |
| D23 | 275 | 6 | 4 | 549 | 5 |
| D23 | 300 | 2.6 | 24 | 374 | 10 |
| D23 | 300 | 2.6 | 98 | 317 | 17 |
| D24 | 250 | 0.1 | 168 | 107 | 19 |
| D24 | 200 | 1.6 | 4 | 394 | 10 |
| D24 | 200 | 1.6 | 6 | 388 | 11 |
| D24 | 200 | 1.46 | 18 | 415 | 4 |
| D25 | 400 | 0.1 | 168 | 101 | 13 |
| D26 | 400 | 0.1 | 168 | 85 | 21 |
| D26 | 300 | 2.6 | 96 | 350 | 7 |
| D27 | 400 | 0.1 | 168 | 78 | 34 |
| D27 | 300 | 2.6 | 96 | 366 | 12 |
| D28 | 400 | 0.1 | 168 | 85 | 13.5 |
| D29 | 200 | 1.46 | 21.5 | 468 | 6 |
| D30 | 200 | 1.46 | 21.5 | 463 | 8 |

### Example 6

Laminated glass articles comprising a glass core layer fused to glass cladding layers (as depicted in FIG. 1) were modelled based on the glass compositions of Tables 5A-5E of Example 4 (showing glass compositions D1-D30 and the glass clad layer compositions of Tables 7A-7C (showing glass compositions E1-E13), below. The laminated glass articles were modelled with a glass core layer having a thickness of 750 μm and glass clad layer having thicknesses of 15 μm (total laminate thickness=780 μm). The stress in the glass clad layers was calculated using the equations described herein. The laminated glass samples were then steam treated under the conditions shown in Tables 7A-7I. The data for various glass core layer and glass clad layer combinations is reported in Tables 7A-7I, below, before and after stream treatment. The reported “clad stress” is the compressive stress of the clad layer without steam treatment. The reported “accumulated surface CS” is the compressive stress following the steam treatment.

Several laminated glass samples are reported where the core is strengthened by steam treatment but the clad is not (e.g., utilizing D22 (core) and D26 (clad), and utilizing E1 (core) and D26 (clad). Although the clad samples may be strengthened under more severe steaming conditions as shown in Example 5, the conditions reported did not increase the compressive stress. However, the majority of the samples show increased surface compressive stress in the clad by steaming as well as increased compressive stress at the edges of the core by steaming.

TABLE 7A
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | D22 | D26 | El | D26 | D14 | D2 |
| CTE (10^{∧}-7) | 94.3 | 51.4 | 108.7 | 51.4 | 91.1 | 77.4 |
| Young′s modulus (GPa) | 62.05 | 79.36 | 48.06 | 79.36 | | 65.64 |
| Poisson′s Ratio | 0.212 | 0.219 | 0.226 | 0.219 | | 0.192 |
| Strain Point (° C.) | 521.1 | 757.7 | 540.9 | 757.7 | 658 | 654.1 |
| Core thickness (um) | 750 | | 750 | | 750 | |
| Clad thickness (um) | | 25 | | 25 | | 25 |
| k | | 15 | | 15 | | 15 |
| E (effect)-core | 88.88 | | 71.53 | | | |
| E (effect)-clad | | 115.84 | | 115.84 | | 89.39 |
| Effective temperature (° C.) | 496.1 | | 515.9 | | | 629.1 |
| Clad stress (Mpa) | | 227 | | 309 | | |
| Steaming conditions and results | | | | | | |
| Temperature (° C) | 225 | 225 | 150 | 150 | 200 | 200 |
| Vapor pressure (Mpa) | 2.6 | 2.6 | 0.5 | 0.5 | 1.6 | 1.6 |
| Time (hours) | 4 | 4 | 6 | 6 | 16 | 16 |
| CS (Mpa) | 422 | 0 | 433 | 0 | 360 | 327 |
| DOL (um) | 6 | 0 | 11 | 0 | 12 | 6 |
| Accumulative surface CS (Mpa) | | 227 | | 309 | | |

TABLE 7B
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E2 | D3 | E2 | D3 | E2 | D3 |
| CTE (10^{∧}-7) | 89.8 | 70.2 | 89.8 | 70.2 | 89.8 | 70.2 |
| Young′s modulus (GPa) | 64.60 | 68.05 | 64.60 | 68.05 | 64.60 | 68.05 |
| Poisson′s Ratio | 0.208 | 0.196 | 0.208 | 0.196 | 0.208 | 0.196 |
| Strain Point (° C.) | 632 | 678.9 | 632 | 678.9 | 632 | 678.9 |
| Core thickness (um) | 750 | | 750 | | 750 | |
| Clad thickness (um) | | 25 | | 25 | | 25 |
| k | | 15 | | 15 | | 15 |
| E (effect)-core | 91.58 | | 91.58 | | 91.58 | |
| E (effect)-clad | | 93.58 | | 93.58 | | 93.58 |
| Effective temperature (° C.) | 607 | | 607 | | 607 | |
| Clad stress (Mpa) | | 104 | | 104 | | 104 |
| Steaming conditions and results | | | | | | |
| Temperature (° C.) | 250 | 250 | 275 | 275 | 275 | 275 |
| Vapor pressure (Mpa) | 4 | 4 | 6 | 6 | 6 | 6 |
| Time (hours) | 16 | 16 | 6 | 6 | 9 | 9 |
| CS (Mpa) | 336 | 389 | 326 | 403 | 298 | 352 |
| DOL (um) | 31 | 11 | 27 | 9 | 35 | 12 |
| Accumulative surface CS (Mpa) | | 493 | | 507 | | 456 |

TABLE 7C
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E3 | D2 | E4 | D2 | E5 | D2 |
| CTE (10^{∧}-7) | 93 | 77.4 | 93.1 | 77.4 | 92.7 | 77.4 |
| Young's modulus (GPa) | 53.02 | 65.64 | 54.40 | 65.64 | 54.61 | 65.64 |
| Poisson′s Ratio | 0.22 | 0.192 | 0.217 | 0.192 | 0.222 | 0.192 |
| Strain Point (° C.) | 569 | 654.1 | 579 | 654.1 | 595 | 654.1 |
| Core thickness (um) | 750 | | 750 | | 750 | |
| Clad thickness (um) | | 25 | | 25 | | 25 |
| k | | 15 | | 15 | | 15 |
| E (effect)-core | 77.61 | | 78.97 | | 80.37 | |
| E (effect)-clad | | 89.39 | | 89.39 | | 89.39 |
| Effective temperature (° C.) | 544 | 629.1 | 554 | 629.1 | 570 | 629.1 |
| Clad stress (Mpa) | | 70 | | 72 | | 73 |
| Steaming conditions and results | | | | | | |
| Temperature (° C.) | 200 | 200 | 200 | 200 | 200 | 200 |
| Vapor pressure (Mpa) | 1.6 | 1.6 | 1.6 | 1.6 | 1.6 | 1.6 |
| Time (hours) | 18 | 16 | 18 | 16 | 18 | 16 |
| CS (Mpa) | 279 | 327 | 294 | 327 | 299 | 327 |
| DOL (um) | 33 | 6 | 32 | 6 | 33 | 6 |
| Accumulative surface CS (Mpa) | | 397 | | 399 | | 400 |

TABLE 7D
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E5 | D2 | E6 | D2 | E7 | D2 |
| CTE (10^{∧}-7) | 92.7 | 77.4 | 93.3 | 77.4 | 97.3 | 77.4 |
| Young′s modulus (GPa) | 54.61 | 65.64 | 53.23 | 65.64 | 52.81 | 65.64 |
| Poisson′s Ratio | 0.222 | 0.192 | 0.215 | 0.192 | 0.22 | 0.192 |
| Strain Point (° C.) | 595 | 654.1 | 548.2 | 654.1 | 548 | 654.1 |
| Core thickness (um) | 750 | | 750 | | 750 | |
| Clad thickness (um) | | 25 | | 25 | | 25 |
| k | | 15 | | 15 | | 15 |
| E (effect)-core | 80.37 | | 76.86 | | 77.30 | |
| E (effect)-clad | | 89.39 | | 89.39 | | 89.39 |
| Effective temperature (° C.) | 570 | 629.1 | 523.2 | 629.1 | 523 | 629.1 |
| Clad stress (Mpa) | | 73 | | 69 | | 86 |
| Steaming conditions and results | | | | | | |
| Temperature (° C.) | 300 | 300 | 200 | 200 | 200 | 200 |
| Vapor pressure (Mpa) | 2.6 | 2.6 | 1.6 | 1.6 | 1.6 | 1.46 |
| Time (hours) | 96 | 96 | 18 | 16 | 16 | 18 |
| CS (Mpa) | 99 | 178 | 243 | 327 | 263 | 471 |
| DOL (um) | 51 | 44 | 31 | 6 | 32 | 5 |
| Accumulative surface CS (Mpa) | | 251 | | 396 | | 557 |

TABLE 7E
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E8 | D2 | E9 | D2 | E10 | D2 |
| CTE (10^{∧}-7) | 96.6 | 77.4 | 96.2 | 77.4 | 95.1 | 77.4 |
| Young′s modulus (GPa) | 54.40 | 65.64 | 54.33 | 65.64 | 55.92 | 65.64 |
| Poisson′s Ratio | 0.222 | 0.192 | 0.22 | 0.192 | 0.223 | 0.192 |
| Strain Point (° C.) | 573.8 | 654.1 | 573.1 | 654.1 | 593.6 | 654.1 |
| Core thickness (um) | 750 | | 750 | | 750 | |
| Clad thickness (um) | | 25 | | 25 | | 25 |
| k | | 15 | | 15 | | 15 |
| E (effect)-core | 80.07 | | 79.52 | | 82.53 | |
| E (effect)-clad | | 89.39 | | 89.39 | | 89.39 |
| Effective temperature (° C.) | 548.8 | 629.1 | 548.1 | 629.1 | 568.6 | 629.1 |
| Clad stress (Mpa) | | 88 | | 86 | | 84 |
| Steaming conditions and results | | | | | | |
| Temperature (° C.) | 200 | 200 | 200 | 200 | 200 | 200 |
| Vapor pressure (Mpa) | 1.6 | 1.6 | 1.6 | 1.6 | 1.6 | 1.6 |
| Time (hours) | 16 | 16 | 16 | 16 | 16 | 16 |
| CS (Mpa) | 274 | 327 | 283 | 327 | 300 | 327 |
| DOL (um) | 29 | 6 | 29 | 6 | 25 | 6 |
| Accumulative surface CS (Mpa) | | 415 | | 413 | | 411 |

TABLE 7F
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E11 | D2 | E12 | D2 | E12 | D2 |
| CTE (10^{∧}-7) | 94 | 77.4 | 102.4 | 77.4 | 102.4 | 77.4 |
| Young′s modulus (GPa) | 55.99 | 65.64 | 55.71 | 65.64 | 55.71 | 65.64 |
| Poisson′s Ratio | 0.222 | 0.192 | 0.196 | 0.192 | 0.196 | 0.192 |
| Strain Point (° C.) | 598.7 | 654.1 | 641.7 | 654.1 | 641.7 | 654.1 |
| Core thickness (um) | 750 | | 750 | | 750 | |
| Clad thickness (um) | | 25 | | 25 | | 25 |
| k | | 15 | | 15 | | 15 |
| E (effect)-core | 82.40 | | 76.61 | | 76.61 | |
| E (effect)-clad | | 89.39 | | 89.39 | | 89.39 |
| Effective temperature (° C.) | 573.7 | 629.1 | 616.7 | 629.1 | 616.7 | 629.1 |
| Clad stress (Mpa) | | 79 | | 128 | | 128 |
| Steaming conditions and results | | | | | | |
| Temperature (° C.) | 200 | 200 | 200 | 200 | 225 | 225 |
| Vapor pressure (Mpa) | 1.6 | 1.6 | 1.6 | 1.6 | 2.6 | 2.6 |
| Time (hours) | 16 | 16 | 16 | 16 | 16 | 16 |
| CS (Mpa) | 314 | 327 | 302 | 327 | 247 | 420 |
| DOL (um) | 25 | 6 | 29 | 6 | 36 | 8 |
| Accumulative surface CS (Mpa) | | 406 | | 455 | | 548 |

TABLE 7G
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E12 | D2 | E13 | D2 | E13 | D2 |
| CTE (10^{∧}-7) | 102.4 | 77.4 | 110.3 | 77.4 | 110.3 | 77.4 |
| Young′s modulus (GPa) | 55.71 | 65.64 | 57.43 | 65.64 | 57.43 | 65.64 |
| Poisson′s Ratio | 0.196 | 0.192 | 0.226 | 0.192 | 0.226 | 0.192 |
| Strain Point (° C.) | 641.7 | 654.1 | 651.2 | 654.1 | 651.2 | 654.1 |
| Core thickness (um) | 750 | | 750 | | 750 | |
| Clad thickness (um) | | 25 | | 25 | | 25 |
| k | | 15 | | 15 | | 15 |
| E (effect)-core | 76.61 | | 85.49 | | 85.49 | |
| E (effect)-clad | | 89.39 | | 89.39 | | 89.39 |
| Effective temperature (° C.) | 616.7 | 629.1 | 626.2 | 629.1 | 626.2 | 629.1 |
| Clad stress (Mpa) | | 128 | | 172 | | 172 |
| Steaming conditions and results | | | | | | |
| Temperature (° C.) | 300 | 300 | 200 | 200 | 225 | 225 |
| Vapor pressure (Mpa) | 2.6 | 2.6 | 1.6 | 1.6 | 2.6 | 2.6 |
| Time (hours) | 24 | 24 | 16 | 16 | 4 | 4 |
| CS (Mpa) | 115 | 258 | 320 | 327 | 375 | 383 |
| DOL (um) | 95 | 22 | 26 | 6 | 13 | 5 |
| Accumulative surface CS (Mpa) | | 386 | | 499 | | 555 |

TABLE 7H
Laminated glass articles

| | Core/Clad Pair | | Core/Clad Pair | | Core/Clad Pair | |
|---|---|---|---|---|---|---|
| Core/Clad | Core | Clad | Core | Clad | Core | Clad |
| Glass Composition | E13 | D2 | E13 | D2 | E2 | D23 |
| CTE (10^{∧}-7) | 110.3 | 77.4 | 110.3 | 77.4 | 89.8 | 60.6 |
| Young′s modulus (GPa) | 57.43 | 65.64 | 57.43 | 65.64 | 64.60 | 73.22 |
| Poisson′s Ratio | 0.226 | 0.192 | 0.226 | 0.192 | 0.208 | 0.215 |
| Strain Point (° C.) | 651.2 | 654.1 | 651.2 | 654.1 | 632 | 724.7 |
| Core thickness (um) | 750 | | 750 | | 750 | |
| Clad thickness (um) | | 25 | | 25 | | 25 |
| k | | 15 | | 15 | | 15 |
| E (effect)-core | 85.49 | | 85.49 | | 91.58 | |
| E (effect)-clad | | 89.39 | | 89.39 | | 105.73 |
| Effective temperature (° C.) | 626.2 | 629.1 | 626.2 | 629.1 | 607 | 699.7 |
| Clad stress (Mpa) | | 172 | | 172 | | 174 |
| Steaming conditions and results | | | | | | |
| Temperature (° C.) | 225 | 225 | 300 | 300 | 250 | 250 |
| Vapor pressure (Mpa) | 2.6 | 2.6 | 2.6 | 2.6 | 4 | 4 |
| Time (hours) | 16 | 16 | 24 | 24 | 16 | 16 |
| CS (Mpa) | 373 | 420 | 72 | 258 | 336 | 482 |
| DOL (um) | 20 | 8 | 98 | 22 | 31 | 5 |
| Accumulative surface CS (Mpa) | | 592 | | 430 | | 656 |

TABLE 7I
Laminated glass articles

Core/Clad Pair

| | | |
|---|---|---|
| Core/Clad | Core | Clad |
| Glass Composition | E2 | D23 |
| CTE (10\hat{ }−7) | 89.8 | 60.6 |
| Young's modulus (GPa) | 64.60 | 73.22 |
| Poisson's Ratio | 0.208 | 0.215 |
| Strain Point (° C.) | 632 | 724.7 |
| Core thickness (um) | 750 | |
| Clad thickness (um) | | 25 |
| k | | 15 |
| E (effect)-core | 91.58 | |
| E (effect)-clad | | 105.73 |
| Effective temperature (° C.) | 607 | 699.7 |
| Clad stress (Mpa) | | 174 |
| Steaming conditions and results | | |
| Temperature (° C.) | 300 | 300 |
| Vapor pressure (Mpa) | 2.6 | 2.6 |
| Time (hours) | 98 | 98 |
| CS (Mpa) | 209 | 374 |
| DOL (um) | 99 | 10 |
| Accumulative surface CS (Mpa) | | 548 |

TABLE 8A
Core glass compositions

| Glass Composition | E1 | E2 | E3 | E4 |
|---|---|---|---|---|
| SiO₂ | 61.09 | 61.77 | 62.18 | 64.05 |
| Al₂O₃ | 10.90 | 15.01 | 11.07 | 10.53 |
| P₂O₅ | 9.51 | 4.97 | 8.39 | 6.96 |
| B₂O₃ | 0.00 | 0.00 | 0.00 | 0.00 |
| Li₂O | 0.00 | 5.02 | 0.00 | 0.00 |
| Na₂O | 0.06 | 0.13 | 0.22 | 0.22 |
| K₂O | 18.44 | 13.04 | 15.68 | 15.75 |
| Rb₂O | 0.00 | 0.00 | 0.00 | 0.00 |
| MgO | 0.00 | 0.00 | 0.00 | 0.00 |
| ZnO | 0.00 | 0.00 | 2.40 | 2.43 |
| SnO₂ | 0.00 | 0.05 | 0.05 | 0.05 |
| Density (g/cm³) | 2.376 | 2.395 | 2.406 | 2.411 |
| CTE *10⁻⁷ (1/° C.) | 110 | 89.8 | 93 | 93.1 |
| Strain Pt. (° C.) | 538 | 632 | 569 | 579 |
| Anneal Pt. (° C.) | 592 | 690 | 629 | 638 |
| Softening Pt. (° C.) | 892.3 | 943 | | 956.8 |
| Stress optical coefficient | 2.946 | 2.916 | 3.121 | 3.091 |
| (nm/mm/MPa) | | | | |
| Refractive index at 589.3 nm | 1.481 | 1.4942 | 1.485 | 1.4865 |

TABLE 8B
Core glass compositions

| Glass Composition | E5 | E6 | E7 | E8 |
|---|---|---|---|---|
| SiO₂ | 63.49 | 60.11 | 59.05 | 60.87 |
| Al₂O₃ | 11.02 | 11.05 | 11.40 | 10.92 |
| P₂O₅ | 6.97 | 8.41 | 8.29 | 6.90 |
| B₂O₃ | 0.00 | 2.00 | 1.99 | 1.97 |
| Li₂O | 0.00 | 0.00 | 0.00 | 0.00 |
| Na₂O | 0.22 | 0.21 | 0.17 | 0.17 |
| K₂O | 15.80 | 15.72 | 16.62 | 16.69 |
| Rb₂O | 0.00 | 0.00 | 0.00 | 0.00 |
| MgO | 0.00 | 0.00 | 0.00 | 0.00 |
| ZnO | 2.44 | 2.44 | 2.42 | 2.43 |
| SnO₂ | 0.05 | 0.05 | 0.05 | 0.05 |
| Density (g/cm³) | 2.411 | 2.411 | 2.418 | 2.423 |
| CTE *10⁻⁷ (1/° C.) | 92.7 | | | |
| Strain Pt. (° C.) | 595 | 548.2 | 548 | 573.8 |
| Anneal Pt. (° C.) | 658 | 605.7 | 606.1 | 632.6 |
| Softening Pt. (° C.) | 963.3 | | | |
| Stress optical coefficient | 3.114 | 3.171 | 3.139 | 3.159 |
| (nm/mm/MPa) | | | | |
| Refractive index at 589.3 nm | 1.4869 | 1.475 | 1.4884 | 1.49 |

TABLE 8C
Core glass compositions

| Glass | | | | | |
|---|---|---|---|---|---|
| Composition | E9 | E10 | E11 | E12 | E13 |
| SiO₂ | 60.43 | 62.44 | 61.97 | 63.44 | 60.95 |
| Al₂O₃ | 11.43 | 10.94 | 11.46 | 10.98 | 12.99 |
| P₂O₅ | 6.89 | 5.40 | 5.37 | 6.56 | 5.65 |
| B₂O₃ | 2.02 | 2.01 | 2.01 | 0.00 | |
| Li₂O | 0.00 | 0.00 | 0.00 | 2.48 | 1.98 |
| Na₂O | 0.17 | 0.16 | 0.17 | 0.05 | |
| K₂O | 16.60 | 16.57 | 16.56 | 16.44 | 18.43 |
| Rb₂O | 0.00 | 0.00 | 0.00 | 0.00 | |
| MgO | 0.00 | 0.00 | 0.00 | 0.00 | |
| ZnO | 2.41 | 2.41 | 2.41 | 0.00 | |
| SnO₂ | 0.05 | 0.05 | 0.05 | 0.05 | |
| Density (g/cm³) | 2.422 | 2.431 | 2.429 | 2.384 | 2.405 |
| CTE *10⁻⁷ | | | | | |
| (1/° C.) | | | | | |
| Strain Pt. (° C.) | 573.1 | 593.6 | 598.7 | 641.7 | 651.2 |
| Anneal Pt. (° C.) | 632.1 | 651.3 | 656.9 | 704.1 | 713.3 |
| Softening Pt. (° | | | | | |
| C.) | | | | | |
| Stress optical | 3.146 | 3.131 | 3.679 | 2.897 | 2.888 |
| coefficient (nm/ | | | | | |
| mm/MPa) | | | | | |
| Refractive index | 1.4903 | 1.4923 | 1.492 | 1.487 | 1.4905 |
| at 589.3 nm | | | | | |

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A laminated glass article comprising:
a glass core layer formed from a core glass composition and comprising an average core coefficient of thermal expansion CTE_{C} from 20° C. temperature to 300° C.; and
at least one glass clad layer fused directly to the glass core layer, the at least one glass clad layer formed from a clad glass composition different than the core glass composition, the at least one glass clad layer comprising an average clad coefficient of thermal expansion CTE_{CL} from 20° C. to 300° C., wherein:
CTE_{C} is greater than or equal to CTE_{CL};
at least a portion of the glass core layer is exposed at an edge of the laminated glass article; and
the glass core layer comprises a hydrogen-containing core zone extending from the edge of the laminated glass article towards a center of the glass core layer, wherein the hydrogen-containing core zone has a core zone penetration depth from the edge of the laminated glass article and a concentration of hydrogen in the hydrogen-containing core zone is greater closer to the edge of the laminated glass article than at the core zone penetration depth.

2. The laminated glass article of claim 1, wherein the core zone penetration depth is greater than or equal to 2 μm.

3. The laminated glass article of claim 1, wherein the hydrogen-containing core zone comprises a compressive stress, wherein the compressive stress decreases as the concentration of hydrogen in the glass core layer decreases.

4. The laminated glass article of claim 3, wherein the compressive stress in the glass core layer in the hydrogen-containing core zone at the edge of the glass core layer is greater than or equal to 100 MPa.

5. The laminated glass article of claim 3, wherein the compressive stress in the glass core layer extends from the edge of the glass core layer to a core zone depth of compression that is greater than or equal to 5 μm.

6. The laminated glass article of claim 1, wherein a differential between CTE_{C} and CTE_{CL} is greater than or equal to 5×10⁻⁷/° C.

7. The laminated glass article of claim 1, wherein the at least one glass clad layer comprises a compressive stress greater than or equal to 150 MPa.

8. The laminated glass article of claim 7, wherein:
the at least one glass clad layer comprises a hydrogen-containing clad zone extending from the edge of the laminated glass article towards a center of the at least one glass clad layer, wherein the hydrogen-containing clad zone has a clad zone penetration depth from the edge of the laminated glass article and a concentration of hydrogen in the hydrogen-containing clad zone is greater closer to the edge of the laminated glass article than at the clad zone penetration depth; and
the core zone penetration depth is greater than the clad zone penetration depth.

9. The laminated glass article of claim 8, wherein the clad zone penetration depth is less than 2 μm.

10. The laminated glass article of claim 1, wherein the clad glass composition is free of alkali metal oxides.

11. The laminated glass article of claim 1, wherein the core glass composition comprises SiO₂, Al₂O₃, and P₂O₅.

12. A method of forming a laminated glass article, the method comprising:
fusing at least one glass clad layer directly to a glass core layer to form a laminated glass article, wherein:
the glass core layer comprises an average core coefficient of thermal expansion CTE_{C} from 20° C. temperature to 300° C.;
the at least one glass clad layer comprises an average clad coefficient of thermal expansion CTE_{CL} from 20° C. to 300° C.; and
CTE_{C} is greater than or equal to CTE_{CL}; and
exposing the laminated glass article to an environment comprising a vapor phase comprising greater than or equal to 300 grams of water/m³ thereby diffusing hydrogen into at least the glass core layer to form a hydrogen-containing core zone extending from an edge of the laminated glass article towards a center of the glass core layer, wherein the hydrogen-containing core zone has a core zone penetration depth from the edge of the laminated glass article and a concentration of hydrogen in the hydrogen-containing core zone is closer to the edge of the laminated glass article than at the core zone penetration depth.

13. The method of claim 12, wherein the environment comprises a temperature greater than or equal to 70° C. during the exposing.

14. The method of claim 12, wherein the environment comprises a pressure greater than or equal to 0.1 MPa.

15. The method of claim 12, wherein the vapor phase comprises greater than or equal to 5000 grams of water/m³.

16. The method of claim 12, wherein the exposing further comprises diffusing hydrogen into the at least one glass clad layer to form a hydrogen-containing clad zone extending from the edge of the laminated glass article towards a center of the at least one glass clad layer, wherein:
the hydrogen-containing clad zone has a clad zone penetration depth from the edge of the laminated glass article;
a concentration of hydrogen in the hydrogen-containing clad zone is greater closer to the edge of the laminated glass article than at the clad zone penetration depth; and
the core zone penetration depth is greater than the clad zone penetration depth.

17. A glass-based article, comprising:
a compressive stress layer extending from a surface of the glass-based article to a depth of compression;
a thickness of less than or equal to 2 mm; and
a hydrogen-containing layer extending from the surface of the glass-based article to a depth of layer, wherein a hydrogen concentration of the hydrogen-containing layer decreases from a maximum hydrogen concentration to the depth of layer;
wherein the depth of compression is greater than 5 μm, the compressive stress layer comprises a compressive stress greater than or equal to 10 MPa, and at least a portion of the glass-based article comprises a glass composition comprising greater than or equal to about 1 mol. % and less than or equal to 20 mol. % Na₂O.

18. A method of forming a glass-based article, the method comprising:
exposing a glass article to an environment comprising a vapor phase comprising greater than or equal to 300 grams of water/m³ thereby diffusing hydrogen into the glass article to form a hydrogen-containing layer extending from the surface of the glass-based article to a depth of layer, wherein a hydrogen concentration of the hydrogen-containing layer decreases from a maximum hydrogen concentration to the depth of layer;
wherein the glass article comprises a glass composition comprising greater than or equal to about 1 mol. % and less than or equal to 20 mol. % Na₂O.

19. A laminated glass article comprising:
a glass core layer formed from a core glass composition and comprising an average core coefficient of thermal expansion CTE_{C} from 20° C. temperature to 300° C.; and
at least one glass clad layer fused directly to the glass core layer, the at least one glass clad layer formed from a clad glass composition different than the core glass composition, the at least one glass clad layer comprising an average clad coefficient of thermal expansion CTE_{CL} from 20° C. to 300° C., wherein:
CTE_{C} is greater than or equal to CTE_{CL}; and
the glass clad layer comprises a hydrogen-containing clad zone extending from the surface of the laminated glass article into the thickness of the glass clad layer, wherein the hydrogen-containing core zone has a clad zone penetration depth from the surface of the laminated glass article and a concentration of hydrogen in the hydrogen-containing clad zone is greater closer to the surface of the laminated glass article than at the clad zone penetration depth.

20. A method of forming a laminated glass article, the method comprising:
fusing at least one glass clad layer directly to a glass core layer to form a laminated glass article, wherein:
the glass core layer comprises an average core coefficient of thermal expansion CTE_{C} from 20° C. temperature to 300° C.;
the at least one glass clad layer comprises an average clad coefficient of thermal expansion CTE_{CL} from 20° C. to 300° C.; and
CTE_{C} is greater than or equal to CTE_{CL}; and
exposing the laminated glass article to an environment comprising a vapor phase comprising greater than or equal to 300 grams of water/m³ thereby diffusing hydrogen into at least the glass clad layer to form a hydrogen-containing clad zone extending from a surface of the laminated glass article into the thickness of the glass clad layer, wherein the hydrogen-containing clad zone has a clad zone penetration depth from the surface of the laminated glass article and a concentration of hydrogen in the hydrogen-containing clad zone is closer to the surface of the laminated glass article than at the clad zone penetration depth.
